(19) United States
(12) Patent Application Publication
(10) Pub. No.: US 2026/0067213 A1
(43) Pub. Date: Mar. 5, 2026

(54) METHOD OF END-TO-END ENCRYPTION AND DECRYPTION THROUGH MULTIPLE OVERLAY NETWORKS

(71) Applicant: Cisco Technology, Inc., San Jose, CA (US)

(72) Inventors: Lianxiang Wang, Shanghai (CN); Bin Shi, Shanghai (CN); Avinash Shah, Pleasanton, CA (US); Alan Xiao-rong Wang, Shanghai (CN); Yunpeng Zhang, Shanghai (CN); Pan Wu, Shanghai (CN)

(21) Appl. No.: 18/818,960

(22) Filed: Aug. 29, 2024

(51) Int. Cl. H04L 45/745; H04L 9/40

(52) U.S. Cl. CPC H04L 45/745; H04L 63/0485

(57) ABSTRACT

A system and method are provided for securely routing data through a series of overlay networks without decrypting and encrypting at boundaries between the overlay networks. The packet is routed through first and second overlay networks, and a second overlay network using a header in which the destination-address field encodes both a nexthop destination address and one or more lookup indices that uniquely that are used to look up subsequent nexthop destination addresses. Using a current destination address in the header, the packet is forwarded through the first overlay network to a first router between the overlay networks. A lookup index in the header is used to look up the next destination address (i.e., a transport address across the second overlay network to a second router), which overwrites the current destination address, so that the modified header can be used to forward the packet to the second router.

### TECHNICAL FIELD

The subject matter of this disclosure relates in general to the field of computer networking, and more particularly to securely routing data through multiple overlay networks whiteout encrypting and decrypting multiple times.

### BACKGROUND

The enterprise network landscape is continuously evolving. There is a greater demand for mobile and Internet of Things (IoT) device traffic, Software as a Service (SaaS) applications, and cloud adoption. In recent years, software-defined enterprise network solutions have been developed to address the needs of enterprise networks. Software-defined enterprise networking is part of a broader technology of software-defined networking (SDN) that includes both software-defined wide area networks (SDWAN) and software-defined local area networks (SDLAN). SDN is a centralized approach to network management which can abstract away the underlying network infrastructure from its applications. This de-coupling of data plane forwarding and control plane can allow a network operator to centralize the intelligence of the network and provide for more network automation, operations simplification, and centralized provisioning, monitoring, and troubleshooting. Software-defined enterprise networking can apply these principles of SDN to the WAN and the LAN.

In Hierarchical SDWAN deployment, the VPN route in remote regions is realized using a protocol in which packets are re-distributed hop by hop through the border router, the traffic from the source region's edge router to the destination region's edge router needs to do encapsulation/encryption and decapsulation/decryption per-hop. So along the path, traffic needs to do encryption and decryption multiple times, which adds overhead and causes latency.

Accordingly, improved techniques are desired for securely routing data through multiple overlay networks without the overhead and latency caused by encrypting and decrypting at each border between overlay networks.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example of a high-level network architecture, in accordance with some embodiments.

FIG. 2 illustrates an example of a network topology, in accordance with some embodiments.

FIG. 3 illustrates an example of an overlay network on an underlay network, in accordance with some embodiments.

FIG. 4A illustrates an example of an operation of a protocol for managing an overlay network, in accordance with some embodiments.

FIG. 4B illustrates an example of operation of a protocol for managing an overlay network providing abbreviated transport addresses, in accordance with some embodiments.

FIG. 5 illustrates an example of an operation of virtual private networks for segmenting a network, in accordance with some embodiments.

FIG. 6A illustrates an example of an internet protocol version 6 (IPv6) header, in accordance with some embodiments.

FIG. 6B illustrates an example of the address field in an IPv6 header including a transport address and two TAGs, in accordance with some embodiments.

FIG. 7A illustrates an example of a system that includes multiple overlay networks, in accordance with some embodiments.

FIG. 7B illustrates an example of the overlay networks publishing transports, in accordance with some embodiments.

FIG. 7C illustrates an example of the overlay networks publishing and redistributing a virtual private network (VPN), in accordance with some embodiments.

FIG. 8A and FIG. 8B illustrate a method for routing packets from a source edge router to a destination edge router through multiple overlay networks without decrypting and re-encrypting between the overlay network, in accordance with one embodiment.

FIG. 9A illustrates an example of a first stage of routing packets from a source edge router to a destination edge router through multiple overlay networks, in accordance with one embodiment.

FIG. 9B illustrates an example of a second stage of routing packets from a source edge router to a destination edge router through multiple overlay networks, in accordance with one embodiment.

FIG. 9C illustrates an example of a third stage of routing packets from a source edge router to a destination edge router through multiple overlay networks, in accordance with one embodiment.

FIG. 9D illustrates an example of a fourth stage of routing packets from a source edge router to a destination edge router through multiple overlay networks, in accordance with one embodiment.

FIG. 10A and FIG. 10B illustrate a method for returning an Internet Control Message Protocol (ICMP) packet when the data packet is dropped in one of the overlay networks, in accordance with one embodiment.

FIG. 11A illustrates an example of a first stage of routing packets from a source edge router to a destination edge router through multiple overlay networks, in accordance with one embodiment

FIG. 11B illustrates an example of a second stage of routing packets from a source edge router to a destination edge router through multiple overlay networks, in accordance with one embodiment.

FIG. 11C illustrates an example of returning an ICMP packet when the packet is dropped, in accordance with one embodiment.

FIG. 11D illustrates an example of routing the ICMP packet along a return path, in accordance with one embodiment.

FIG. 11E illustrates an example of the ICMP packet being received and consumed at the source edge, in accordance with one embodiment.

FIG. 12 illustrates a block diagram of an example of a computing device, in accordance with some embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In some aspects, the techniques described herein relate to a method of securely routing data through a series of overlay networks without decrypting and encrypting at boundaries between the overlay networks, the method including: routing a packet along a path through a plurality of overlay networks including a source edge router, a first overlay network, and a second overlay network, wherein the packet includes a payload that is encrypted and a header that is unencrypted, and the header includes a destination-address field that is configured to encode both a nexthop destination address and one or more lookup indices that uniquely identify respective subsequent nexthop destination addresses in a lookup table; receiving the packet at a first border router between the first overlay network and the second overlay network, the destination-address field encoding at least a first transport address and a first lookup index that uniquely identifies, in a first lookup table, a second transport address corresponding to transport route to a second border router of the second overlay network; modifying, by the first border router, the destination-address field to include the second destination address to provide a modified header; and using the destination-address field of the modified header to forward the packet through the second overlay network to the second border router.

In some aspects, the techniques described herein relate to a method, wherein: the plurality of overlay networks includes a third overlay network that includes the second border router and a destination edge border router, the destination-address field of the header at the source edge router encodes the first transport address, the first lookup index, and a second lookup index, and the method further includes: using the first transport address of the header to forward the packet through the first overlay network from the source edge router to the first border router; looking up, at the first border router, a transport address associated with the first lookup index in the first lookup table to provide the second transport address; modifying, by the first border router, the destination-address field by replacing the first transport address with the second transport address; looking up, at the second border router, a transport address associated with the second lookup index in a second lookup table to provide the third transport address; modifying, by the first border router, the destination-address field of the modified header by replacing the second transport address with the third transport address to provide another modified header; and using the destination-address field of the another modified header to forward the packet through the third overlay network to the destination edge router.

In some aspects, the techniques described herein relate to a method, wherein the header includes a source-address field that is configured to encode both a source transport address and a return-path lookup index that uniquely identifies an egress transport address of a previous hop in the lookup table, and the method further includes: looking up, at the first border router, in the first lookup table a lookup index that is associated with the source transport address in the source-address field of the header to provide a third lookup index; and modifying, by the first border router, the source-address field to replace source transport address in the source-address field with an egress transport address of the first border router and adding the third lookup index to the source-address field to provide a modified header.

In some aspects, the techniques described herein relate to a method, further including: returning a notification message indicating that the packet was dropped, when the packet is dropped in the second overlay network, wherein a destination-address field of a header of the notification message at the first border router is the source-address field of the modified header of the packet; looking up, at the first border router, in the first lookup table a transport address associated with the third lookup index to provide a return-path transport address; modifying, by the first border router, the destination-address field of the header the notification message by replacing the transport address in the destination-address field of the notification message with the return-path transport address to provide a modified header of the notification message; and using the destination-address field of the modified header of the notification message to forward the notification message through the first overlay network to the source edge router.

In some aspects, the techniques described herein relate to a method, further including: publishing overlay transports for the plurality of overlay networks, the overlay transports being represented by abbreviated transport addresses that are shorter than a length of the destination-address field; recording, in a look up accessible by a router at a border between two overlay networks, published transport addresses to other border routers of the two overlay network and associating the published transport addresses with respective lookup indices; publishing and redistributing virtual network routes through the plurality of overlay networks including a virtual network route that forwards data along the path through the plurality of overlay networks from the source edge router to a destination edge router, wherein a destination address for the virtual network route that is stored at the source edge router includes all information needed to forward the data to the destination edge router, a same key for the virtual network route is redistributed to all border routers along the path including the source edge router, the destination edge router, the first border router, and the second border router; encrypting, at the source edge router, the packet using the same key for the virtual network route; and decrypting, at the destination edge router, the packet for a first time using the same key for the virtual network route.

In some aspects, the techniques described herein relate to a method, wherein encrypting the packet further includes encapsulating the packet; and decrypting the packet further includes decapsulating the packet.

In some aspects, the techniques described herein relate to a method, wherein: the first transport address representing a transport route from a source router of the first overlay network to the first border router, the destination-address field is configured to encode a destination address in a first part of the destination-address field and to encode one or more lookup indices in a second part of the destination-address field; and modifying the destination-address field to include the second destination address includes: searching the first lookup table for the first lookup index and retrieving a transport address associated with the first lookup index, the associated transport address being the second transport address; replacing the first transport address in the first part of the destination-address field with the second transport address; and modifying the second part of the destination-address field to indicate that the first lookup index has been used.

In some aspects, the techniques described herein relate to a method, wherein modifying the second part of the destination-address field to indicate that the first lookup index has been used includes removing the first lookup index from the destination-address field.

In some aspects, the techniques described herein relate to a method, wherein modifying the second part of the destination-address field to indicate that the first lookup index has been used includes: left-shifting bits in the destination-address field by a number of bits in the first lookup index, removing the first lookup index from the destination-address field, or updating a value that signals which lookup index in the destination-address field is used next.

In some aspects, the techniques described herein relate to a method, wherein the first part of the destination-address field includes bits [1, . . . , N] of the destination-address field, the second part of the destination-address field includes bits [N+1, . . . , L], the first lookup index is stored in bits [N+1, . . . , N+M] of the destination-address field, and a second lookup index is stored in bits [N+M+1, . . . , N+2M] of the destination-address field, wherein N is a length for transport addresses, M is a length for lookup indices, and L is a length of the destination-address field.

In some aspects, the techniques described herein relate to a method, wherein modifying the destination-address field of the header is performed by left shifting bits in the destination-address field by M bits and writing over bits [1, . . . , N] with a retrieved transport address from a given lookup table.

In some aspects, the techniques described herein relate to a method, wherein the header is an IPv6 header that has a length of 128 bits, transport addresses that are stored in the header have a length that is between 48 bits and 96 bits; and lookup indices that are stored in the header have a length that is between 32 bit and 16 bits.

In some aspects, the techniques described herein relate to a method, wherein: transport addresses that are stored in the header have a prefix portion and a host portion, and lookup indices that are stored in the header have a region portion and a transport-address index portion.

In some aspects, the techniques described herein relate to a method, wherein a hash look up using the first lookup index is used by the first border router to retrieve the second transport address from the first lookup table.

In some aspects, the techniques described herein relate to a system including: one or more processors; and a memory storing instructions that, when executed by the one or more processors, configure the system to: route a packet along a path through a plurality of overlay networks including a source edge router, a first overlay network, and a second overlay network, wherein the packet includes a payload that is encrypted and a header that is unencrypted, and the header includes a destination-address field that is configured to encode both a nexthop destination address and one or more lookup indices that uniquely identify respective subsequent nexthop destination addresses in a lookup table; receive the packet at a first border router between the first overlay network and the second overlay network, the destination-address field encoding at least a first transport address and a first lookup index that uniquely identifies, in a first lookup table, a second transport address corresponding to transport route to a second border router of the second overlay network; modify, by the first border router, the destination-address field to include the second destination address to provide a modified header; and use the destination-address field of the modified header to forward the packet through the second overlay network to the second border router.

In some aspects, the techniques described herein relate to a system, wherein the plurality of overlay networks includes a third overlay network that includes the second border router and a destination edge border router, the destination-address field of the header at the source edge router encodes the first transport address, the first lookup index, and a second lookup index, and the instructions further configure the system to: use the first transport address of the header to forward the packet through the first overlay network from the source edge router to the first border router; look up, at the first border router, a transport address associated with the first lookup index in the first lookup table to provide the second transport address; modify, by the first border router, the destination-address field by replacing the first transport address with the second transport address; look up, at the second border router, a transport address associated with the second lookup index in a second lookup table to provide the third transport address; modify, by the first border router, the destination-address field of the modified header by replacing the second transport address with the third transport address to provide another modified header; and use the destination-address field of the another modified header to forward the packet through the third overlay network to the destination edge router.

In some aspects, the techniques described herein relate to a system, wherein: the header includes a source-address field that is configured to encode both a source transport address and a return-path lookup index that uniquely identifies an egress transport address of a previous hop in the lookup table, and the instructions further configure the system to: look up, at the first border router, in the first lookup table a lookup index that is associated with the source transport address in the source-address field of the header to provide a third lookup index; and modify, by the first border router, the source-address field to replace source transport address in the source-address field with an egress transport address of the first border router and adding the third lookup index to the source-address field to provide a modified header.

In some aspects, the techniques described herein relate to a system, wherein the instructions further configure the system to: return a notification message indicating that the packet was dropped, when the packet is dropped in the second overlay network, wherein a destination-address field of a header of the notification message at the first border router is the source-address field of the modified header of the packet; look up, at the first border router, in the first lookup table a transport address associated with the third lookup index to provide a return-path transport address; modifying, by the first border router, the destination-address field of the header the notification message by replacing the transport address in the destination- address field of the notification message with the return-path transport address to provide a modified header of the notification message; and use the destination-address field of the modified header of the notification message to forward the notification message through the first overlay network to the source edge router.

In some aspects, the techniques described herein relate to a system, wherein the instructions further configure the system to: publish overlay transports for the plurality of overlay networks, the overlay transports being represented by abbreviated transport addresses that are shorter than a length of the destination-address field; recording, in a look up accessible by a router at a border between two overlay networks, published transport addresses to other border routers of the two overlay network and associating the published transport addresses with respective lookup indices; publish and redistributing virtual network routes through the plurality of overlay networks including a virtual network route that forwards data along the path through the plurality of overlay networks from the source edge router to a destination edge router, wherein a destination address for the virtual network route that is stored at the source edge router includes all information needed to forward the data to the destination edge router, a same key for the virtual network route is redistributed to all border routers along the path including the source edge router, the destination edge router, the first border router, and the second border router; encrypt, at the source edge router, the packet using the same key for the virtual network route; and decrypt, at the destination edge router, the packet for a first time using the same key for the virtual network route.

In some aspects, the techniques described herein relate to a system, wherein the instructions further configure the system to: encrypt and encapsulate the packet; and decrypt and decapsulate the packet.

In some aspects, the techniques described herein relate to a system, wherein: the first transport address representing a transport route from a source router of the first overlay network to the first border router, the destination-address field is configured to encode a destination address in a first part of the destination-address field and to encode one or more lookup indices in a second part of the destination-address field; and the instructions further configure the system to: modify the destination-address field to include the second destination address includes: searching the first lookup table for the first lookup index and retrieving a transport address associated with the first lookup index, the associated transport address being the second transport address; replace the first transport address in the first part of the destination-address field with the second transport address; and modify the second part of the destination-address field to indicate that the first lookup index has been used.

In some aspects, the techniques described herein relate to a system, wherein the instructions further configure the system to: modify the second part of the destination-address field to indicate that the first lookup index has been used by removing the first lookup index from the destination-address field.

In some aspects, the techniques described herein relate to a system, wherein the instructions further configure the system to: modify the second part of the destination-address field to indicate that the first lookup index has been used by: left-shifting bits in the destination- address field by a number of bits in the first lookup index, removing the first lookup index from the destination-address field, or updating a value that signals which lookup index in the destination-address field is used next.

In some aspects, the techniques described herein relate to a system, wherein: the first part of the destination-address field includes bits [1, . . . ,N] of the destination-address field, the second part of the destination-address field includes bits [N+1, . . . ,L], the first lookup index is stored in bits [N+1, . . . , N+M] of the destination-address field, and a second lookup index is stored in bits [N+M+1,,N+2M] of the destination-address field, wherein N is a length for transport addresses, M is a length for lookup indices, and L is a length of destination-address field.

In some aspects, the techniques described herein relate to a system, wherein the instructions further configure the system to: modify the destination-address field of the header by left shifting bits in the destination-address field by M bits and writing over bits [1, . . . , N] with a retrieved transport address from a given lookup table.

In some aspects, the techniques described herein relate to a system, wherein the header is an IPv6 header that has a length of 128 bits, transport addresses that are stored in the header have a length that is between 48 bits and 96 bits; and lookup indices that are stored in the header have a length that is between 32 bit and 16 bits.

In some aspects, the techniques described herein relate to a system, wherein: transport addresses that are stored in the header have a prefix portion and a host portion, and lookup indices that are stored in the header have a region portion and a transport-address index portion.

In some aspects, the techniques described herein relate to a system, wherein a hash look up using the first lookup index is used by the first border router to retrieve the second transport address from the first lookup table.

In some aspects, the techniques described herein relate to a non-transitory computer-readable storage medium, the computer-readable storage medium including instructions that when executed by a computer, cause the computer to: route a packet along a path through a plurality of overlay networks including a source edge router, a first overlay network, and a second overlay network, wherein the packet includes a payload that is encrypted and a header that is unencrypted, and the header includes a destination-address field that is configured to encode both a nexthop destination address and one or more lookup indices that uniquely identify respective subsequent nexthop destination addresses in a lookup table; receive the packet at a first border router between the first overlay network and the second overlay network, the destination-address field encoding at least a first transport address and a first lookup index that uniquely identifies, in a first lookup table, a second transport address corresponding to transport route to a second border router of the second overlay network; modify, by the first border router, the destination-address field to include the second destination address to provide a modified header; and use the destination-address field of the modified header to forward the packet through the second overlay network to the second border router.

In some aspects, the techniques described herein relate to a non-transitory computer-readable storage medium, wherein the plurality of overlay networks includes a third overlay network that includes the second border router and a destination edge border router, the destination-address field of the header at the source edge router encodes the first transport address, the first lookup index, and a second lookup index, and the instructions further cause the computer to: use the first transport address of the header to forward the packet through the first overlay network from the source edge router to the first border router; look up, at the first border router, a transport address associated with the first lookup index in the first lookup table to provide the second transport address; modify, by the first border router, the destination-address field by replacing the first transport address with the second transport address; look up, at the second border router, a transport address associated with the second lookup index in a second lookup table to provide the third transport address; modify, by the first border router, the destination-address field of the modified header by replacing the second transport address with the third transport address to provide another modified header; and use the destination-address field of the another modified header to forward the packet through the third overlay network to the destination edge router.

In some aspects, the techniques described herein relate to a non-transitory computer-readable storage medium, wherein: the header includes a source-address field that is configured to encode both a source transport address and a return-path lookup index that uniquely identifies an egress transport address of a previous hop in the lookup table, and the instructions further cause the computer to: look up, at the first border router, in the first lookup table a lookup index that is associated with the source transport address in the source-address field of the header to provide a third lookup index; and modify, by the first border router, the source-address field to replace source transport address in the source-address field with an egress transport address of the first border router and adding the third lookup index to the source-address field to provide a modified header.

In some aspects, the techniques described herein relate to a non-transitory computer-readable storage medium, wherein the instructions further cause the computer to: return a notification message indicating that the packet was dropped, when the packet is dropped in the second overlay network, wherein a destination-address field of a header of the notification message at the first border router is the source-address field of the modified header of the packet; look up, at the first border router, in the first lookup table a transport address associated with the third lookup index to provide a return-path transport address; modifying, by the first border router, the destination-address field of the header the notification message by replacing the transport address in the destination-address field of the notification message with the return-path transport address to provide a modified header of the notification message; and use the destination-address field of the modified header of the notification message to forward the notification message through the first overlay network to the source edge router.

In some aspects, the techniques described herein relate to a non-transitory computer-readable storage medium, wherein the instructions further cause the computer to: publish overlay transports for the plurality of overlay networks, the overlay transports being represented by abbreviated transport addresses that are shorter than a length of the destination-address field; recording, in a look up accessible by a router at a border between two overlay networks, published transport addresses to other border routers of the two overlay network and associating the published transport addresses with respective lookup indices; publish and redistributing virtual network routes through the plurality of overlay networks including a virtual network route that forwards data along the path through the plurality of overlay networks from the source edge router to a destination edge router, wherein a destination address for the virtual network route that is stored at the source edge router includes all information needed to forward the data to the destination edge router, a same key for the virtual network route is redistributed to all border routers along the path including the source edge router, the destination edge router, the first border router, and the second border router; encrypt, at the source edge router, the packet using the same key for the virtual network route; and decrypt, at the destination edge router, the packet for a first time using the same key for the virtual network route.

In some aspects, the techniques described herein relate to a non-transitory computer-readable storage medium, wherein the instructions further cause the computer to: encrypt and encapsulate the packet; and decrypt and decapsulate the packet.

In some aspects, the techniques described herein relate to a non-transitory computer-readable storage medium, wherein: the first transport address representing a transport route from a source router of the first overlay network to the first border router, the destination-address field is configured to encode a destination address in a first part of the destination-address field and to encode one or more lookup indices in a second part of the destination-address field; and the instructions further cause the computer to: modify the destination-address field to include the second destination address includes: searching the first lookup table for the first lookup index and retrieving a transport address associated with the first lookup index, the associated transport address being the second transport address; replace the first transport address in the first part of the destination-address field with the second transport address; and modify the second part of the destination-address field to indicate that the first lookup index has been used.

In some aspects, the techniques described herein relate to a non-transitory computer-readable storage medium, wherein the instructions further cause the computer to: modify the second part of the destination-address field to indicate that the first lookup index has been used by removing the first lookup index from the destination-address field.

In some aspects, the techniques described herein relate to a non-transitory computer-readable storage medium, wherein the instructions further cause the computer to: modify the second part of the destination-address field to indicate that the first lookup index has been used by: left-shifting bits in the destination-address field by a number of bits in the first lookup index, removing the first lookup index from the destination-address field, or updating a value that signals which lookup index in the destination-address field is used next.

In some aspects, the techniques described herein relate to a non-transitory computer-readable storage medium, wherein: the first part of the destination-address field includes bits [1, . . . ,N] of the destination-address field, the second part of the destination-address field includes bits [N+1, . . . , L], the first lookup index is stored in bits [N+1, . . . , N+M] of the destination-address field, and a second lookup index is stored in bits [N+M+1,,N+2M] of the destination-address field, wherein N is a length for transport addresses, M is a length for lookup indices, and L is a length of destination-address field.

In some aspects, the techniques described herein relate to a non-transitory computer-readable storage medium, wherein the instructions further cause the computer to: modify the destination-address field of the header by left shifting bits in the destination-address field by M bits and writing over bits [1, . . . ,N] with a retrieved transport address from a given lookup table.

In some aspects, the techniques described herein relate to a non-transitory computer-readable storage medium, wherein the header is an IPv6 header that has a length of 128 bits, transport addresses that are stored in the header have a length that is between 48 bits and 96 bits; and lookup indices that are stored in the header have a length that is between 32 bit and 16 bits.

In some aspects, the techniques described herein relate to a non-transitory computer-readable storage medium, wherein: transport addresses that are stored in the header have a prefix portion and a host portion, and lookup indices that are stored in the header have a region portion and a transport-address index portion.

In some aspects, the techniques described herein relate to a non-transitory computer- readable storage medium, wherein a hash look up using the first lookup index is used by the first border router to retrieve the second transport address from the first lookup table.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for providing end to end secure data flow through multiple overlay networks without needing to perform encryption/decryption at the borders between overlay networks. All information required to route the packet through encryption/decryption multiple times is contained in the encapsulation header outside the encrypted payload. The entire path of the packet will include respective routes the corresponding overlay networks. The source and destination address fields can include an abbreviated address corresponding to a route through the current overlay networks, and the information identifying the other routes can be provided by even shorter TAGs (also referred to as lookup indices) that can be used to look up the abbreviated addresses for the other routes through the other overlay networks. Databases associating the TAGs with abbreviated address can be accessible by border routers, such that the abbreviated address needed for the next overlay network can be looked up and retrieved, when the packet reaches a border between overlay networks.

The total number of bits for the combination of the abbreviated address and the TAGs is less than or equal to the address fields in the encapsulation header. For example, the abbreviated address can be 80 bits, and each tag can be 24 bits, such that the length of an abbreviated address together with two TAGs is 128 bits, which is the length of the address fields in IPv6. Further, of an abbreviated address together with two TAGs provides sufficient information to traverse three overlay networks using only information in the unencrypted encapsulation header.

According to certain non-limiting examples, the systems and methods disclosed herein overcome the challenge in hierarchical software defined wide area networks (SDWAN) using IPv6 transport to provide end-to-end encryption and decryption. In Hierarchical SDWAN deployment, the VPN route in remote regions is realized using a protocol in which packets are re-distributed hop by hop through Border router, the traffic from source region's edge router to destination region's edge router needs to do encapsulation/encryption and decapsulation/decryption per-hop. So along the path, traffic needs to do encryption and decryption multiple times, which adds overhead and causes latency.

According to certain non-limiting examples, the systems and methods disclosed herein eliminate the need to encrypt and decrypt the packets multiple times by using micro transport locators (uTLOCs), which use abbreviated transports addresses, e.g., in IPv6, these can be 80 bits rather than the 128 bits of other transport addresses), together with TAGs, which are even shorter and can be used as lookup indices to retrieve uTLOC transports addresses at databases between regions/overlay networks. For example, when the uTLOC transports addresses have a length of 80 bits and the TAGs have a length of 24 bits, one uTLOC transports address (80 bits) and two TAGs (each 24 bits) can fit in a 128-bit IPv6 address field (e.g., 80 bits+24 bits+24 bits=128 bits). This enables a route of three hops through three overlay networks while encrypting and decrypting only once.

In view of the above, the systems and methods disclosed herein can leverage IPv6 address schema using a lookup table concept called a micro-Transport Locator (μTLOC). When an overlay management protocol (OMP) VPN route is published, the nexthop is the combination of all μTLOCs along the path. Each router can program a customized action based on the routing table for a respective uTLOC prefix, and the router forwards the data packets to the destination edge without decryption/re-encryption in any of the intermediate border routers.

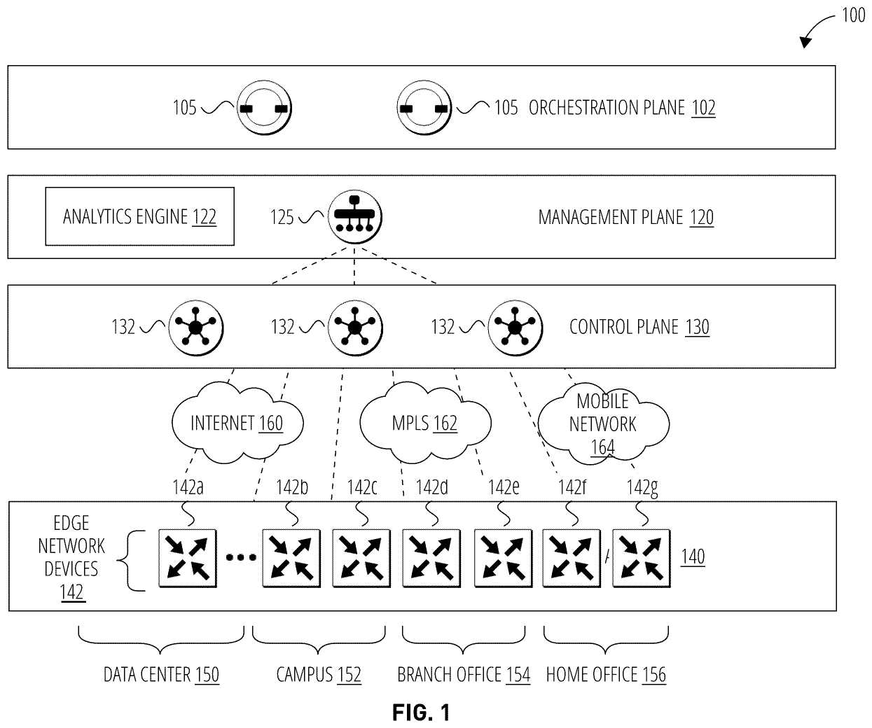

FIG. 1 illustrates an example of a network architecture 100 for implementing aspects of the present technology. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 120, a control plane 130, and a data plane 140. The orchestration plane 102 can assist in the automatic on-boarding of edge network devices 142 (e.g., switches, routers, etc.) in an overlay network. The orchestration plane 102 can include one or more physical or virtual network orchestrator appliances. Network orchestrator appliances 105 can perform the initial authentication of edge network devices 142 (e.g., edge network devices 142a, 142b, 142c, 142d, 142e, 142f, and 142g) and orchestrate connectivity between devices of the control plane 130 and the data plane 140. In some embodiments, network orchestrator appliances 105 can also enable communication of devices located behind Network Address Translation (NAT). In some embodiments, physical or virtual Cisco® SD-WAN vBond appliances can operate as network orchestrator appliances 105.

The management plane 120 can be responsible for the central configuration and for monitoring a network. The management plane 120 can include one or more physical or virtual network management appliances. In some embodiments, network management appliances 125 can provide centralized management of the network via a graphical user interface to enable a user to monitor, configure, and maintain edge network devices 142 and links (e.g., internet transport network 160, MPLS network 162, 4G/Mobile network 164) in an underlay and overlay network. Network management appliances 125 can support multi-tenancy and enable centralized management of logically isolated networks associated with different entities (e.g., enterprises, divisions within enterprises, groups within divisions, etc.). Alternatively or additionally, network management appliances 125 can be a dedicated network management system for a single entity. In some embodiments, physical or virtual Cisco® SD-WAN vManage appliances can operate as network management appliances 125.

The control plane 130 can build and maintain a network topology and make decisions on where traffic flows. The control plane 130 can include one or more physical or virtual network control appliances. Network control appliances 132 can establish secure connections to edge network devices 142 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network control appliances 132 can operate as route reflectors. Network control appliances 132 can also orchestrate secure connectivity in the data plane 140 between and among edge network devices 142. For example, in some embodiments, network control appliances 132 can distribute crypto key information among edge network devices 142. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as network control appliances 132.

The data plane 140 can be responsible for forwarding packets based on decisions from the control plane 130. The data plane 140 can include edge network devices 142, which can be physical or virtual edge network devices. Edge network devices 142 can operate at the edges of network environments of an organization, such as in data centers 150, campus networks 152, branch office networks 154, home office networks 156, and so forth, or in the cloud (e.g., Infrastructure as a Service (IaaS), Platform as a Service (PaaS), SaaS, and other cloud service provider networks). Edge network devices 142 can provide secure data plane connectivity among sites over one or more WAN transports, such as via internet transport network 160 (e.g., Digital Subscriber Line (DSL), cable, etc.), MPLS networks 162 (or other private packet-switched network (e.g., Metro Ethernet, Frame Relay, Asynchronous Transfer Mode (ATM), etc.), mobile networks 164 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). Edge network devices 142 can be responsible for traffic forwarding, security, encryption, quality of service (QOS), and routing (e.g., BGP, OSPF, etc.), among other tasks. In some embodiments, physical or virtual Cisco® SD-WAN vEdge routers can operate as edge network devices 142.

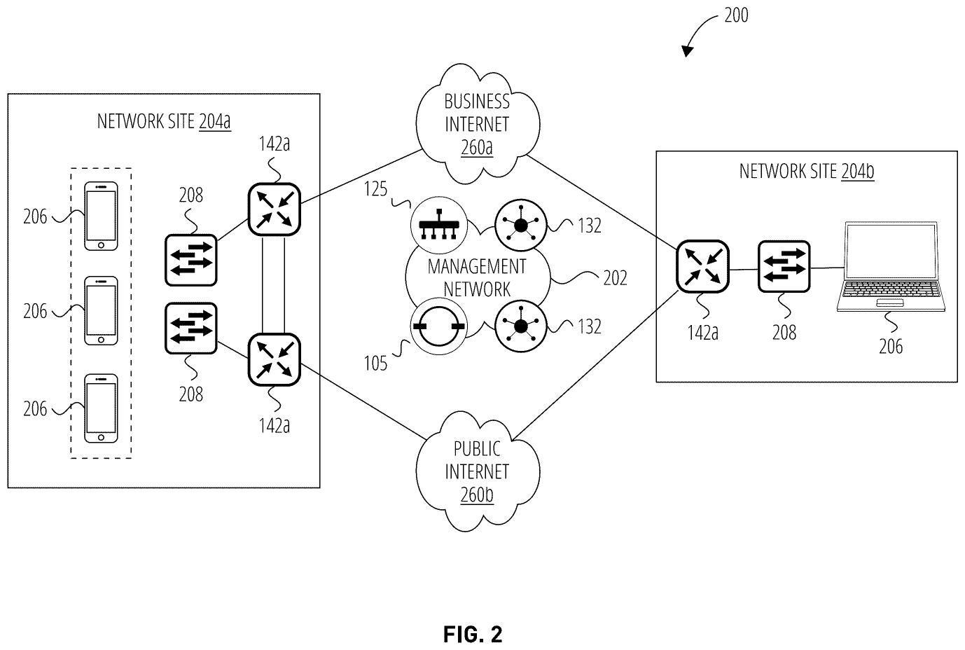

FIG. 2 illustrates an example of a network topology 200 for showing various aspects of the network architecture 100. The network topology 200 can include a management network 202, a pair of network site 204a and network site 204b (e.g., local networks such as data centers 150, campus networks 152, branch office networks 154, home office networks 156, cloud service provider networks, etc.), and a pair of transport links such as transport network 260a and transport network 260b. The management network 202 can include network orchestrator appliances 105, network management appliance 122, and network control appliances 132. Although the management network 202 is shown as a single network in this example, one of ordinary skill in the art will understand that each element of the management network 202 can be distributed across any number of networks and/or be co-located with network site 204a and network site 204b. In this example, each element of the management network 202 can be reached through either one of the transport links, transport network 260a, or transport network 260b.

Each site can include endpoints 206 connected to site network devices 208. The endpoints 206 can include general purpose computing devices (e.g., servers, workstations, desktop computers, etc.), mobile computing devices (e.g., laptops, tablets, mobile phones, etc.), wearable devices (e.g., watches, glasses or other head-mounted displays (HMDs), car devices, etc.), and so forth. The endpoints 206 can also include Internet of Things (IoT) devices or equipment, such as agricultural equipment (e.g., livestock tracking and management systems, watering devices, unmanned aerial vehicles (UAVs), etc.); connected cars and other vehicles; smart home sensors and devices (e.g., alarm systems, security cameras, lighting, appliances, media players, HVAC equipment, utility meters, windows, automatic doors, door bells, locks, etc.); office equipment (e.g., desktop phones, copiers, fax machines, etc.); healthcare devices (e.g., pacemakers, biometric sensors, medical equipment, etc.); industrial equipment (e.g., robots, factory machinery, construction equipment, industrial sensors, etc.); retail equipment (e.g., vending machines, point of sale (POS) devices, Radio Frequency Identification (RFID) TAGS, etc.); smart city devices (e.g., street lamps, parking meters, waste management sensors, etc.); transportation and logistical equipment (e.g., turnstiles, rental car trackers, navigational devices, inventory monitors, etc.); and so forth.

The site network devices 208 can include physical or virtual switches, routers, and other network devices. Although network site 204a is shown including a pair of site network devices and network site 204b is shown including a single site network device in this example, the site network devices 208 can include any number of network devices in any network topology, including multi-tier (e.g., core, distribution, and access tiers), spine-and-leaf, mesh, tree, bus, hub and spoke, and so forth. For example, one or more data center networks may implement the Cisco® Application Centric Infrastructure (ACI) architecture and/or one or more campus networks may implement the Cisco® Software Defined Access (SD-Access or SDA) architecture. The site network devices 208 can connect the endpoints 206 to edge network devices 142, and the edge network devices 142 can be used to directly connect to the external networks such as internet transport network 160.

In some examples, “color” can be used to identify an individual transport network, and different transport networks may be assigned different colors (e.g., MPLS, private1, biz-internet, metro-ethernet, LTE, etc.). For example, the network topology 200 can utilize a color called “biz-internet” for transport network 260a and a color called “public-internet” for transport network 260b.

In some examples, site network devices 208 can form a Datagram Transport Layer Security (DTLS) or TLS control connection to network control appliances 132 and connect to any network control appliances 132 over each of transport network 260a and transport network 260b. In some examples, edge network devices 142 can also securely connect to edge network devices in other sites via IPSec tunnels. In some embodiments, the BFD protocol may be used within each of these tunnels to detect loss, latency, jitter, and path failures.

On edge network devices 142, color can be used help to identify or distinguish an individual transport tunnel (e.g., no same color may be used twice on a single edge network device). Colors by themselves can also have significance. For example, the colors may be private colors, which can be used for private networks or in places where there is no NAT addressing of the transport IP endpoints (e.g., because there may be no NAT between two endpoints of the same color). When edge network devices 142 use a private color, they may attempt to build IPSec tunnels to other edge network devices using native, private, underlay IP addresses. The public colors can include 3 g, biz, internet, blue, bronze, custom1, custom2, custom3, default, gold, green, LTE, public-internet, red, and silver. The public colors may be used by edge network devices 142 to build tunnels to post-NAT IP addresses (if there is NAT involved). If edge network devices 142 use private colors and need NAT to communicate to other private colors, the carrier setting in the configuration can dictate whether edge network devices 142 use private or public IP addresses. Using this setting, two private colors can establish a session when one or both are using NAT.

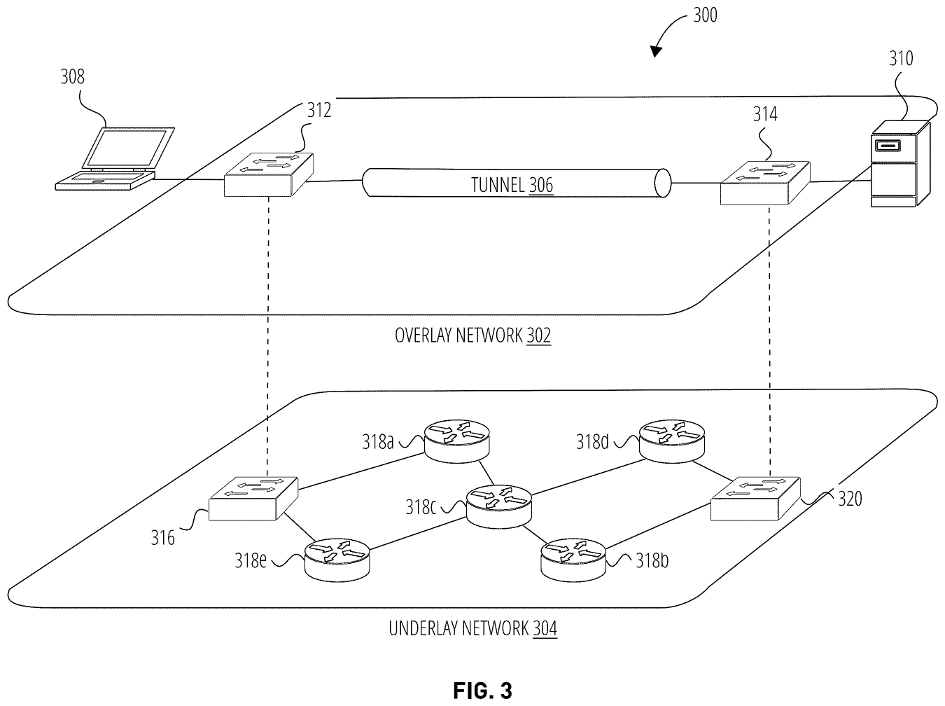

FIG. 3 illustrates a system 300 that includes an overlay network 302, which is a virtual network, that operates on an underlay network 304, which is an actual, physical network. Virtual, overlay networks can be used to implement encapsulation protocols such as VXLAN packets, Generic Routing Encapsulation (GRE) or Generic UDP Encapsulation (GUE) to encapsulate data and send it through a tunnel 306. For example, SD-WAN implementation can use IPsec UDP-based overlay network layer protocol encapsulation as defined in RFC-4023. Parts of the description of system 300 use a non-limiting example of a VXLAN overlay network to illustrate general aspects of overlay networks. However, the systems and methods disclosed herein are not limited to a particular overlay network technology, as would be understood by a person of ordinary skill in the art.

For example, GRE is a tunneling protocol that can encapsulate a wide variety of network layer protocols inside virtual point-to-point links or point-to-multipoint links over an Internet Protocol network. GUE provides encapsulation of user data (Application layer) into a UDP datagram (Transport layer) over IP (Network layer) inside some Data link layer protocol. Generic Network Virtualization Encapsulation (Geneve) is a network encapsulation protocol created by the IETF in order to unify the efforts made by other initiatives like VXLAN and NVGRE, with the intent to eliminate the wild growth of encapsulation protocols.

In FIG. 3, overlay network 302 can include virtual switch 312 that corresponds to a physical switch 316 and receives ingress data from a source node 308 (e.g., a user device, such as a laptop or smart phone) encapsulates data and sends it through tunnel 306 to virtual switch 314. Virtual switch 314 corresponds to a physical switch 320 and decapsulates the received encapsulated data. After decapsulation, virtual switch 314 sends data to destination node 310 (e.g., a server).

In FIG. 3, underlay network 304 can include a physical switch 316, a physical switch 320, and a series of routers (e.g., router 318a, a router 318b, a router 318c, a router 318d, and a router 318e) that make up a network fabric.

According to certain non-limiting examples, overlay network 302 can be a VXLAN overlay network. The virtual switch 312 and virtual switch 314 can be VXLAN Tunnel EndPoints (VTEPs) that provide connectivity between overlay network 302 and underlay network 304 networks. The VTEP can perform frame encapsulation into VXLAN packets to transport them across IP networks (e.g., the underlay network 304) and perform de-encapsulation upon exiting the VXLAN channel (e.g., tunnel 306). The underlay network 304 can operate without any awareness op the VXLAN. That is, the underlay network 304 treats the VXLAN packet just like any other normal packet. The VTEPs can be hardware based or software based (e.g., VXLAN capable hypervisor switch in hypervisor host). For example, a hypervisor host can be instantiated in a host of a data processing unit (DPU). The VTEPs can have two interfaces: (i) a local LAN interface and an IP interface. The local LAN interface can provide local communication by bridging endpoints (e.g., source node 308 or the destination node 310) connected to VTEPs. The IP interface can connect the underlay layer 3 network also known as transport network. The IP address are bound to the IP interface to uniquely identify VTEP in the network.

Overlay network 302 and underlay network 304 can operate the independently of each other. Overlay network 302 is virtual and requires the underlay network 304 to function. Changes made in overlay network 302, however, do not impact the underlay network 304. For example, links can be added/removed in the underlay network as long as destination is reachable by routing protocol overlay network remains unchanged.

Returning to the non-limiting VXLAN example, encapsulation (decapsulation) of VXLAN traffic can be done by the VTEPs adding (removing) additional fields. These additional fields can include, e.g., (i) an external MAC address (e.g., tunnel endpoint VTEP destination media access control address); (ii) an external source MAC address (e.g., tunnel VTEP source Mac address); (iii) an external destination IP address (e.g., tunnel endpoint VTEP destination IP address); (iv) an external source IP address (e.g., tunnel VTEP source IP address); and (v) an external UDP header (e.g., UDP port: 4789). VXLAN can act as an extension for VLAN (layer 2) and extend layer 2 segments so tenant workload can be distributed across physical pods in data centers. VXLAN can provides 24-bit segment ID referred as VXLAN network identifier (VNID) to enable 16 million VXLAN segments. VXLAN can transmit packets through underlay network based on layer 3 header and it takes advantage of layer 3 routing, ECMP routing and all other available routing protocols to use all paths.

VXLAN is discussed here to illustrate one non-limiting example of network virtualization. Generally, there are many examples of network virtualization, such as GRE, GUE, and Geneve. For example, a description of Geneve can be found in RFC-8926, and IPsec UDP-based overlay network layer protocol encapsulation as defined in RFC-4023. A person of ordinary skill in the art would understand, that when the systems and methods disclosed herein use network virtualization, any of the available techniques can be used.

According to certain non-limiting examples, virtual switch 312 and the virtual switch 314 can be implemented in hosts on DPUs that are proximate (within the network) to source node 308 and destination node 310

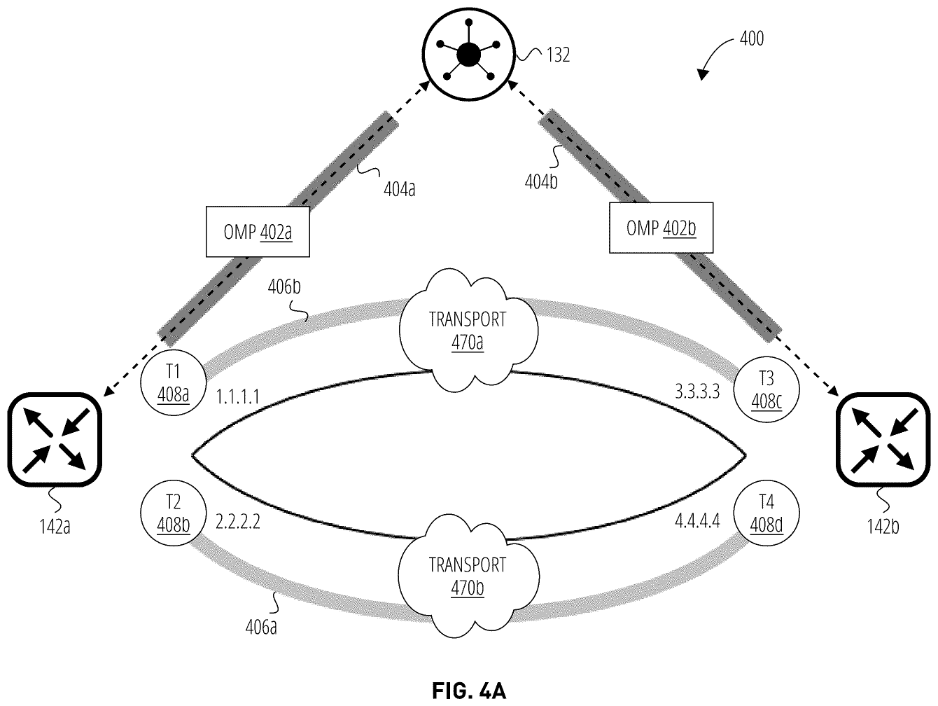

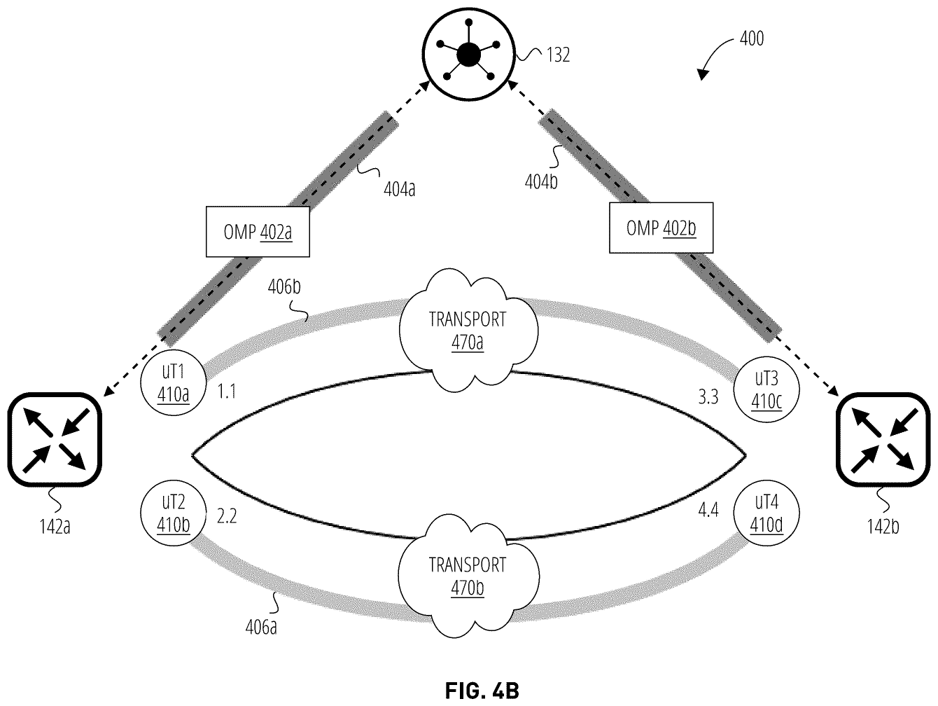

FIG. 4A illustrates an example of an overlay architecture 400 used for an overlay management protocol (OMP), which may be used in some examples to manage an overlay of a network (e.g., the network architecture 100). In this example, OMP messages 402a and OMP messages 402b may be transmitted back and forth between network control appliances 132 and edge network devices 142a and 142b, respectively, where control plane information, such as route prefixes, next-hop routes, crypto keys, policy information, and so forth, can be exchanged over respective secure DTLS or TLS connections 404a and 404b. In some examples, one or more trigger conditions used in the designation of the edge network devices 142 as primary or secondary can be based on OMP messages 402a or OMP messages 402b. Network control appliances 132 can operate similarly to a route reflector. For example, network control appliances 132 can receive routes from the edge network devices 142, process and apply any policies to them, and advertise routes to other edge network devices 142 in the overlay. If there is no policy defined, the edge network devices 142 may behave in a manner similar to a full mesh topology, where each edge network device can connect directly to another edge network device at another site and receive full routing information from each site.

The OMP can advertise different OMP routes. In an example, an OMP route can correspond to prefixes that are learned from the local site, or service side, of the edge network device. The prefixes can be originated as static or connected routes, or from within, For example, the OSPF or BGP protocols, and redistributed into OMP so they can be carried across the overlay. OMP routes can advertise attributes such as transport location (TLOC) information (which can be similar to a BGP next-hop IP address) and other attributes such as origin, originator, preference, site identifier, tag, and virtual private network (VPN). An OMP route may be installed in the forwarding table if the TLOC to which it points is active.

In another example, OMP routes can include TLOC routes, which can correspond to logical tunnel termination points on the edge network devices 142 that connect to one or more external networks through one or more transport links. In some embodiments, a TLOC route can be uniquely identified and represented by a three-tuple, including an IP address, link color, and encapsulation (e.g., Generic Routing Encapsulation (GRE), IPSec, etc.). In addition to system IP address, color, and encapsulation, TLOC routes can also carry attributes such as TLOC private and public IP addresses, carrier, preference, site identifier, tag, and weight. In some embodiments, a TLOC may be in an active state on a particular edge network device when an active BFD session is associated with that TLOC.

In another example, OMP routes can include Service routes, which can represent services (e.g., firewall, distributed denial of service (DDoS) mitigator, load balancer, intrusion prevent system (IPS), intrusion detection systems (IDS), WAN optimizer, etc.) that may be connected to the local sites of the edge network devices 142 and accessible to other sites for use with service insertion. In addition, these routes can also include VPNs; the VPN labels can be sent in an update type to tell network control appliances 132 what VPNs are serviced at a remote site.

In the example of FIG. 4A, OMP is shown running over TLS/DTLS connection 404a and TLS/DTLS connection 404b established between the edge network devices 142 and network control appliances 132. In addition, overlay architecture 400 shows an IPSec tunnel 406a established between TLOC 408a and 408c over WAN transport link 470a and an IPSec tunnel 406b established between TLOC 408b and TLOC 408d over WAN transport link 470b. Once the IPSec tunnels 406a and 406b are established, BFD can be enabled across each of them.

FIG. 4B illustrates an example of an overlay architecture 400 in which OMP messages 402a and OMP messages 402b establish IPSec tunnel 406a and IPSec tunnel 406b that use abbreviated transport addresses called micro transport location (μTLOC or μTLOC) address in place of the full length addresses used for the TLOCs in FIG. 4A.

FIG. IPv4 addresses are illustrated in FIG. 4A and FIG. 4B. For the IPv4 case, the full-length TLOC transport addresses are 32-bit addresses, and the μTLOC transport addresses are illustrated as being 16-bit addresses. The example of the IPv4 uTLOC transport addresses being 16 bits is non-limiting, and other lengths can be used.

For the IPv6 case, the full-length TLOC transport addresses are 128-bit addresses, and the μTLOC transport addresses are illustrated as being 80-bit addresses. The example of the IPv6 μTLOC transport addresses being 80 bits is non-limiting, and other lengths can be used.

Returning to the IPv4 case illustrated in FIG. 4B, whereas 32-bit addresses are used for the TLOCs in FIG. 4A (e.g., the address 1.1.1.1 corresponds to TLOC 408a), 16-bit addresses are used for the μTLOCs in FIG. 4B (e.g., the address 1.1 corresponds to uTLOC 410a). Accordingly, overlay architecture 400 shows an IPSec tunnel 406a established between uTLOC 410a and uTLOC 410c over WAN transport link 470a and an IPSec tunnel 406b established between uTLOC 410b and uTLOC 410d over WAN transport link 470b. Once IPSec tunnel 406a and IPSec tunnel 406b are established, BFD can be enabled across each of them.

Using abbreviated transport addresses within the overlay networks can improve efficiency when packets are routed through multiple overlay networks. The endpoints (e.g., border routers) encrypt/decrypt and encapsulate/decapsulate the data passing through the overlay network, which works well when only a single overlay network lies along the path from the source to the destination. However, when the path from the source to the destination includes several overlay network, it can be inefficient to decapsulate and decrypt the data exiting one overlay network only to encrypt and encapsulate the data as it enters the next overlay network. A more efficient approach is to encrypt and encapsulate the data once at the beginning of the first overlay network and only decapsulate and decrypt the data as it exits the last overlay network. To avoid decapsulating and decrypting and then re-encrypting and re-encapsulating between overlay networks, the information used to route the data through each overlay network should be conveyed outside the encrypted payload (e.g., in a header of the encapsulated packet). Using μTLOCs together with longer source and destination address fields, information of a multi-overlay-network route can be encoded in the source and destination addresses of the packet headers, which are outside the encrypted payload.

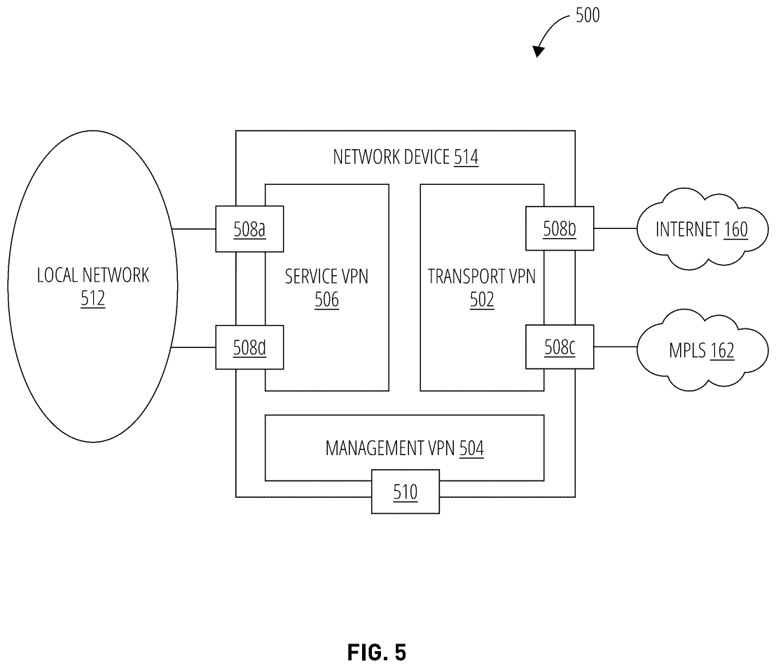

FIG. 5 illustrates an example of operation of VPN system 500 that includes network device 514. In some examples, VPN system 500 can provide segmentation for a network (e.g., the network architecture 100). In some examples, two or more VPNs can be isolated from one another and can have their own forwarding or routing tables. An interface or sub-interface can be explicitly configured under a single VPN and may not be part of more than one VPN. Labels may be used in OMP route attributes and in the packet encapsulation, which can identify the VPN to which a packet belongs. The VPN number can be a four-byte integer with a value from 0 to 65530. In some examples, network orchestrator appliances 105, network management appliances 125, network control appliances 132, and/or edge network devices 142 can each include a transport VPN 502 (e.g., VPN number 0) and a management VPN 504. The transport VPN 502 can include one or more physical or virtual network interfaces (e.g., interface 508a and interface 508b) that respectively connect to the transport links such as WAN transport networks (e.g., for connecting to external networks such as the MPLS network 162 and the internet transport network 160). Secure DTLS/TLS connections to or between network control appliances 132 and network orchestrator appliances 105 can be initiated from the transport VPN 502. In addition, static or default routes or a dynamic routing protocol can be configured inside the transport VPN 502 to get appropriate next-hop information so that the control plane 130 may be established and IPSec tunnels (e.g., IPSec tunnel 406a and IPSec tunnel 406b) can connect to remote sites.

Management VPN 504 can carry out-of-band management traffic to and from network orchestrator appliances 105, network management appliances 125, network control appliances 132, and/or edge network devices 142 over a network interface (e.g., interface 510). In some embodiments, management VPN 504 may not be carried across the overlay network.

In addition to transport VPN 502 and management VPN 504, network orchestrator appliances 105, network management appliances 125, network control appliances 132, or edge network devices 142 can also include service-side VPN 506. The service-side VPN 506 can include one or more physical or virtual network interfaces (e.g., interface 508a and interface 508b) that connect to local network 512 and carry user data traffic. The service-side VPN 506 can be enabled for features such as OSPF or BGP, Virtual Router Redundancy Protocol (VRRP), QoS, traffic shaping, policing, and so forth. In some embodiments, user traffic can be directed over IPSec tunnels to other sites by redistributing OMP routes received from network control appliances 132 at local network 512 into the service-side VPN routing protocol. In turn, routes from local network 512 can be advertised to other sites by advertising the service VPN routes into the OMP routing protocol, which can be sent to network control appliances 132 and redistributed to edge network devices 142 in the network. Although interface 508a, interface 508b, interface 508c, interface 508d and, interface 510 are shown to be physical interfaces in this example, one of ordinary skill in the art will appreciate that these interfaces in the transport and service VPNs can also be sub-interfaces instead.

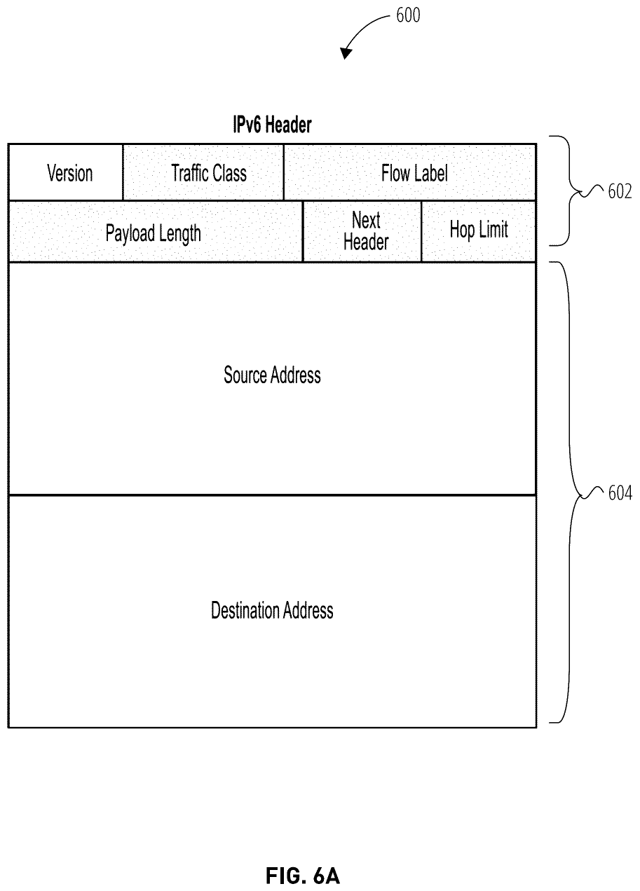

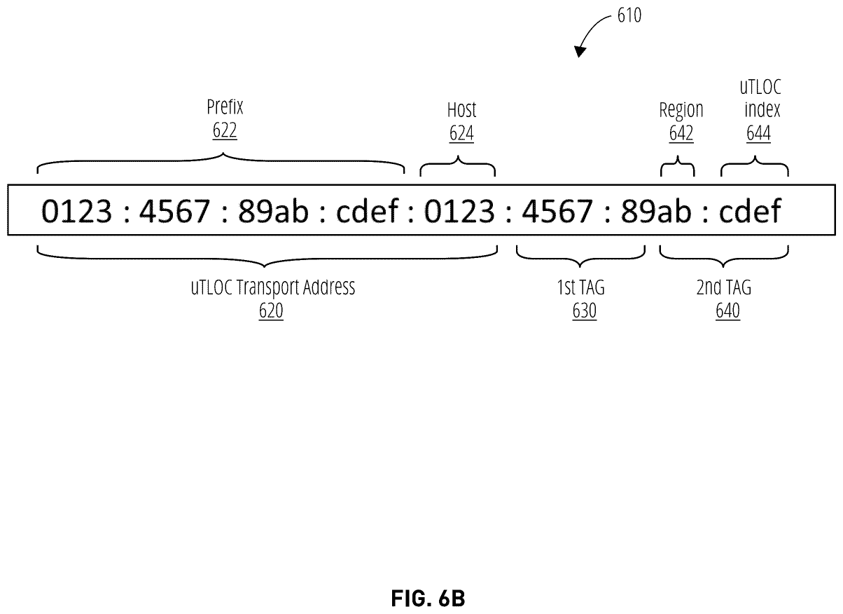

FIG. 6A illustrates an Internet Protocol version 6 (IPv6) IPv6 header 600 for an IPv6 packet, which is the smallest message entity exchanged using Internet Protocol version 6 (IPv6). Packets include headers 600 that have control information 602 and addressing information 604 for routing, and the packets include a payload of user data. The control information in IPv6 packets is subdivided into a mandatory fixed header (e.g., the IPv6 header 600) and optional extension headers. The payload of an IPv6 packet can be a datagram or segment of the higher-level transport layer protocol. Additionally or alternatively, the payload of an IPv 6 packet can be data for an internet layer (e.g., ICMPv6) or link layer (e.g., OSPF) instead.

IPv6 packets can be transmitted over the link layer (i.e., over Ethernet or Wi-Fi), which encapsulates each packet in a frame. Packets may also be transported over a higher-layer tunneling protocol.

Routers do not fragment IPv6 packets larger than the maximum transmission unit (MTU). A minimum MTU of 1,280 octets is used by IPv6. Hosts are recommended to use Path MTU Discovery to take advantage of MTUs greater than the minimum.

IPv6 is uses two distinct types of headers: (i) IPv6 header 600 and IPv6 Extension Headers. For example, the IPv6 header 600 can be similar to the basic IPv4 header despite some field differences that are the result of lessons learned from operating IPv4.

FIG. 6B illustrates an example of including a μTLOC transport address in the high 80 bits of a 128 bit IPv6 address field (e.g., address field 610) and including two TAGs (e.g., 1st TAG 630 and 2nd TAG 640) in the remaining 48 bits of the IPv6 address field.

Address field 610 uses 80 bits for uTLOC transport address 620, which includes a 64-bit prefix (e.g., prefix 622) and a 16-bit host (e.g., host 624). Allocating 16 bits for host 624 results in as many as 65535 TLOCs within one region. This overcomes the constraint that allocating IPv6 address with 32 bits prefix is not practical. Multiple 80 bit μTLOC transport address cannot fit in a 128 bit IPv6 address field. Thus, the 80 bit μTLOC transport address is included for only the first hop, and 24-bit TAGs are used to represent the uTLOCs of subsequent hops. For the complete path of three hops (local region access router->local border router->remote border router->remote access router), the overall combined transport IPv6 destination address is 80 bits (local border router's μTLOC transport address) plus 24 bits (TAG for looking up the remote border router's μTLOC transport address) plus 24 bits (TAG for looking up the remote access router's μTLOC transport address), which equals 128 bits. Using TAGs to look up the uTLOC transport address is facilitated by a TAG-to-uTLOC database (TAG2UTLOC DB). According to certain non-limiting examples, the TAG2UTLOC DB can be maintained locally in each border router.

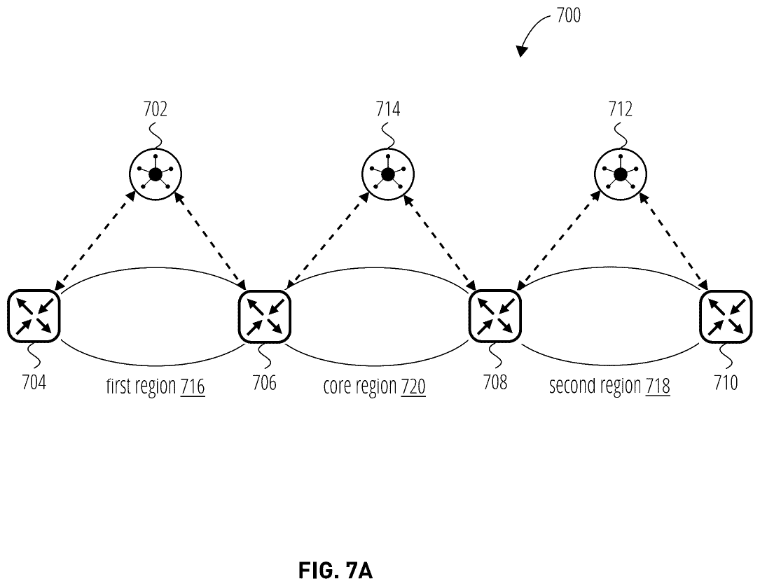

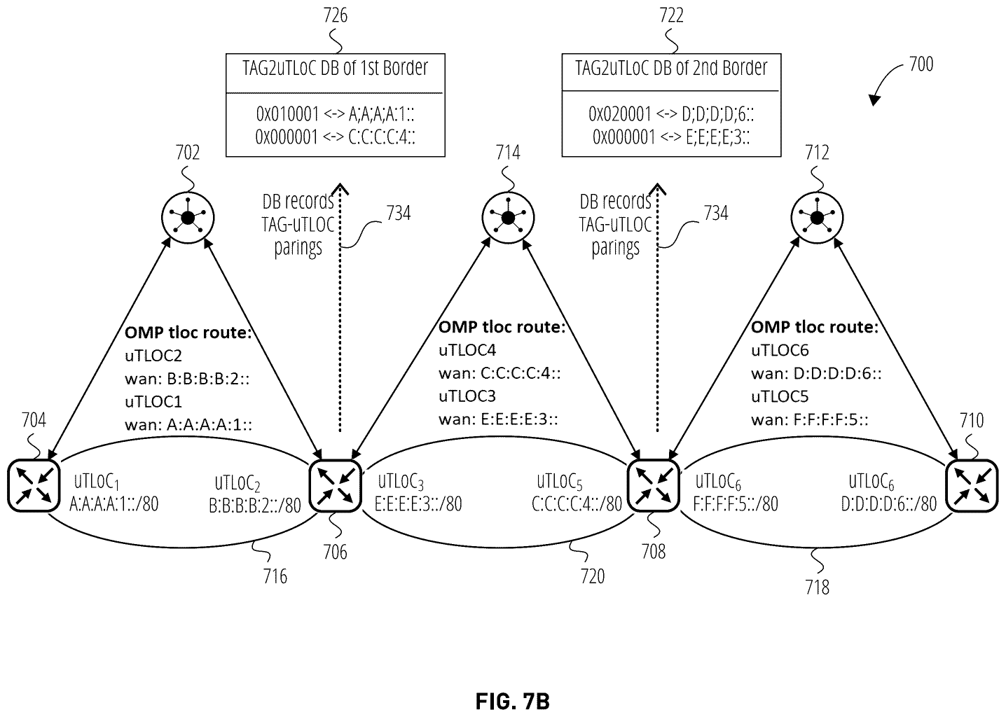

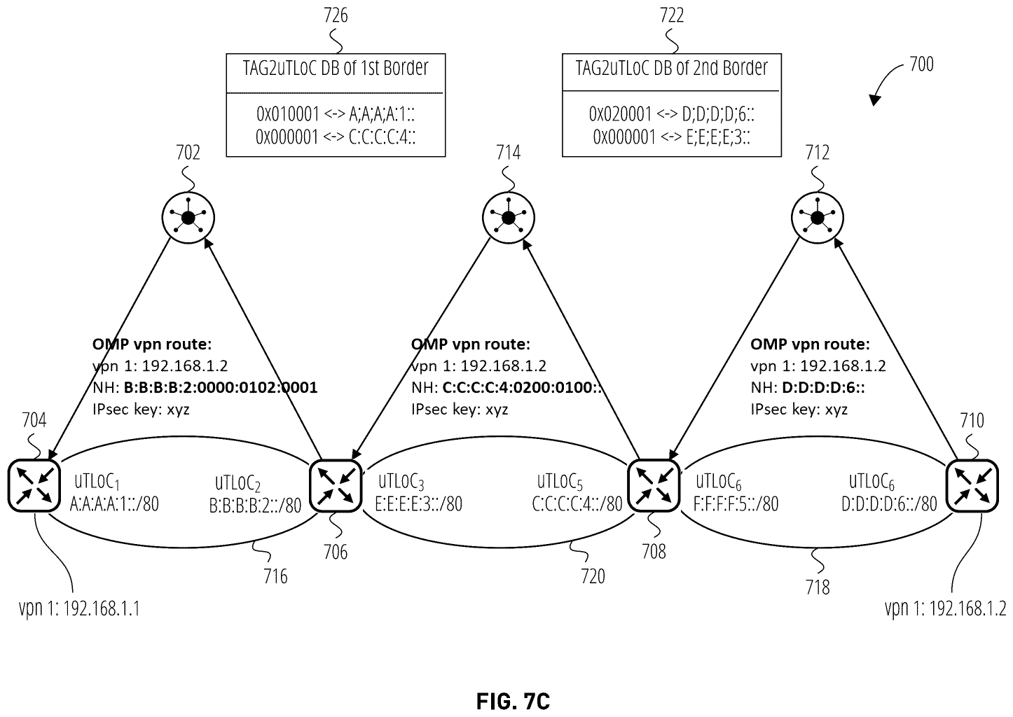

Each TAG (e.g., 2nd TAG 640) can include a region code (e.g., region 642, which is 8 bits) and a uTLOC index (e.g., uTLOC index 644, which is 16 bits). For example, in Hierarchical SDWAN deployment, when TLOC routes are published via an OMP protocol, the border routers can receive TLOC information from its access region and from the core region, as illustrated in FIG. 7A and FIG. 7B. When receiving uTLOC routes, the border router can allocate an unused TAG (24 bits) for that new uTLOC, and the border router can record the TAG together with the associated μTLOC transport address in the TAG2UTLOC database. According to certain non-limiting examples, the 24 bits of the TAG can be split into 8 bits and 16 bits, with 8 bits representing up to 256 regions or sub-regions that can be served by the border router and the remaining 16 bits representing up to 65535 TLOCs within each region.

FIG. 7A illustrates an example of a network 700 that includes multiple overlay networks, each of the overlay networks being established like overlay architecture 400 in FIG. 4A. A first overlay network includes first region 716, border router 704, border router 706, and network control appliance 702. A second overlay network includes core region 720, border router 708, border router 706, and network control appliance 714. A third overlay network includes second region 718, border router 708, border router 710, and network control appliance 712.

A packet that is routed the source region's edge router (i.e., border router 704) to the destination region's edge router (i.e., border router 710) is routed along a path from border router 704 (e.g., the source edge) through the first region 716 to border router 706, then through core region 720 to border router 708, and finally through second region 718 to border router 710 ((e.g., the destination edge).

If this path is traversed using full-length transport addresses for the routes through the overlay networks, the packet will be decapsulated and decrypted as it egresses from each overlay network, and then the packet is again encrypted and encapsulated as it ingresses into the next overlay network. For example, in a hierarchy software-defined wide area network (SDWAN) deployment, the VPN route in a remote region is redistributed hop-by-hop through a border router, and the traffic from the source region's edge router to the destination region's edge router undergoes each of the processes of encapsulation, encryption, decryption, and decapsulation at each hop. Consequently, along the path, traffic shown in FIG. 7A each of these processes encapsulation, encryption, decryption, and decapsulation are each performed three time, once for each hop. This introduces overhead and causes latency.

The systems and methods disclosed herein provide end-to-end security while avoiding the overhead and latency caused by encrypting, encapsulating, decapsulating, and decrypting multiple times. For example, the systems and methods disclosed herein can leverage an IPv6 address schema using the uTLOC concept introduced in FIG. 4B and FIG. 6B. When the OMP VPN route is published, the nexthop is the combination of all uTLOCs along the path. Each border router uses TAGs to look up the uTLOC prefix for the nexthop, such that the encapsulated packet can be forward to the destination edge without decryption and re-encryption at the intermediate border routers.

FIG. 7B illustrates an example of publishing the uTLOC routes and storing the uTLOC transport addresses together with their associated TAGs in a TAG2uTLOC database at the border routers. First, the TLOC routes are published within each region (shown in FIG. 7B), and, then, the VPN route is published and redistributed (shown in FIG. 7C).

For example, when receiving uTLOC route, a region allocates an unused TAG (e.g., a lookup index having a length of 24 bits) for that new uTLOC in the tag together with the associated transport address are recoded in a TAG2UTLOC database. The transport address can be, e.g., 24 bits, which can be split into an 8 bit region code and a 16 bit TLOC code representing TLOC routes. For example, the 8 bit region code can represent at most 256 regions or sub-regions that each border router can serve, and the 16 bit TLOC code can represent at most 65535 TLOCs within each region.

An overlay management protocol (OMP) publish the routes, as illustrated in FIG. 4A and FIG. 4B. For example, in Hierarchical SDWAN deployment, when TLOC routes are published via the OMP protocol, border routers will receive TLOC information (including the uTLOC routes and transport addresses) from its access region and core region. For example, the uTLOC transport addresses can be abbreviated addresses that are 80 bits long, rather than the 128 bit TLOC transport addresses. FIG. 7B shows that these abbreviated transport addresses can be associated with TAGs (e.g., lookup indices), and the abbreviated transport addresses with their associated TAGs can be recorded in the TAG2uTLOC databases (e.g., TAG2uTLoC DB of 2nd border 722 and TAG2uTLoC DB of 1st Border 726).

For each of the regions (e.g., overlay networks), OMP establishes the TLOC routes having uTLOCs with transport addresses.

For example, in first region 716, uTLOC₁ with transport address A:A:A:A:1:: is published for border router 704, and uTLOC₂ with transport address B:B:B:B:2:: is published for border router 706. Similarly, in second region 718, uTLOC₅ with transport address F:F:F:F:5:: is published for border router 708, and a uTLOC₆ with transport address D:D:D:D:6:: is published for border router 710. And, in core region 720, uTLOC₃ with transport address E:E:E:E:3:: is published for border router 708, and uTLOC₄ with transport address C:C:C:C:4:: is published for border router 708.

The respective border routers receive the transport addresses for the neighboring regions, allocates unique TAGs for each of the received transport addresses and record these in a TAG2uTLOC database (e.g., DB records TAG-uTLOC parings 734).

For example, border router 708 receives uTLOC₆ with transport address D:D:D:D:6:: from the access router for second region 718 (i.e., border router 710) and allocates TAG 0×020001 for the transport address of uTLOC₆. Additionally, border router 708 receives uTLOC₃ with transport address E:E:E:E:3:: from border router 706 in core region 720 and allocates TAG 0×00001 for the transport address of uTLOC₃. These TAGS are recorded with their associated transport addresses in TAG2uTLoC DB of 2nd border 722.

Further, border router 706 receives uTLOC₅ with transport address C:C:C:C:4:: from border router 708 in core region 720 and allocates TAG 0×010001 for the transport address of uTLOC₅. Additionally, border router 706 receives uTLOC₁ with transport address A:A:A:A:1:: from border router 704 in first region 716 and allocates TAG 0×00001 for the transport address of uTLOC₁. These TAGS are recorded with their assocaited transport addresses in TAG2uTLoC DB of 1st Border 726.

FIG. 7C illustrates the regions publishing VPN routes and redistributing the VPN routes.

When a VPN route is published from the remote region's access router, the VPN will carry its uTLOC as nexthop (NH). Then, when a border router redistribute this VPN route, the border router will get the original nexthop's high 80 bits, which is used for a hash look up in the TAG2UTLOC DB to get 24 bits TAG. The address field is then right-shifted (e.g., returning to FIG. 6B, the 24 bits of the original nexthop moves from the position of 1st TAG 630, i.e., bits 81-104, to the position of 2nd TAG 640, i.e., bits 105-128). Next, the uTLOC transport address writes over bits 1-80 of the address field, and bits 81-104 of the address field are replaced by the retrieved TAG corresponding to the transport address of the original nexthop.

This process is repeated by each border router until the source edge is reached. Upon reaching the source region's edge (e.g. border router 704) the resulting VPN route with nexthop is combination of local border router's uTLOC transport address (80 bits), the remote border router's TAG (24 bits), and the remote access router's TAG (24 bits), which is a total of 128 bits.

FIG. 7C provides a non-limiting example of the redistribution of the VPN routes. First, second region 718 publishes VPN route 192.168.1.2, which has a nexthop (NH) of D:D:D:D:6::and a IPSec key of xyz. Second, border router 708 receives VPN route 192.168.1.2 from the access router with nexthop uTLOC₆. Border router 708 uses the high 80 bits D:D:D:D:6 (i.e., the transport address of uTLOC₆) to do a hash look up of the corresponding the 24-bit TAG “020001” in TAG2uTLoC DB of 2nd border 722. Third, the VPN route for uTLOC₄ is generated by, right-shifting the previous VPN address by 24 bits, replacing the high 80 bits in the address field with uTLOC transport address of border router 708 (i.e., C:C:C:C:4) and replacing bits 81-105 the TAG “020001” corresponding to the previous nexthop. Accordingly, the VPN route that is published for uTLOC₄ is C:C:C:C:4:0200:0100::.

This process is then repeated at border router 706. First, core region 720 redistributes the VPN route 192.168.1.2 (e.g., C:C:C:C:4:0200:0100::). Second, border router 706 receives VPN route 192.168.1.2, and uses the high 80 bits C:C:C:C:4 (i.e., the transport address of uTLOC₅) to do a hash look up of the corresponding the 24-bit TAG “000001” in TAG2uTLoC DB of 1st Border 726. Third, the VPN route for uTLOC₄ is generated by, right-shifting the previous VPN address by 24 bits, replacing the high 80 bits in the address field with the uTLOC transport address of border router 708 (i.e., B:B:B:B:2::) and replacing bits 81-105 the TAG “000001” corresponding to the previous nexthop. Accordingly, the VPN route that is published for uTLOC₄ is B:B:B:B:2:0000:0102:0001. Finally, first region 716 redistributes the VPN route 192.168.1.2 (e.g., B:B:B:B:2:0000:0102:0001), and border router 704 receives VPN route 192.168.1.2.

According to certain non-limiting examples, the VPN publish and redistribute process can be summarized by the pseudocode:
prefix:host::/128:
for-us
prefix:host::/80:
get dest bits [80:103] to do hash look up in TAG2UTLOC to get next uTLOC
left-shift dest 24 bits
replace dest high 80 bits with next uTLOC and re-look up
get src bits[0:79] to do hash look up in TAG2UTLOC to get src TAG
right-shift src 24 bits
replace src high 124 bits with egress local TLOC and src TAG

When the VPN route is published from the access router, the IPsec key xyz is also carried in the VPN route. The border routers do not change the IPsec key when republishing the VPN route, so the source region access router (e.g., border router 704) will have the IPsec key associated with the VPN route of the remote access router (e.g., border router 710).

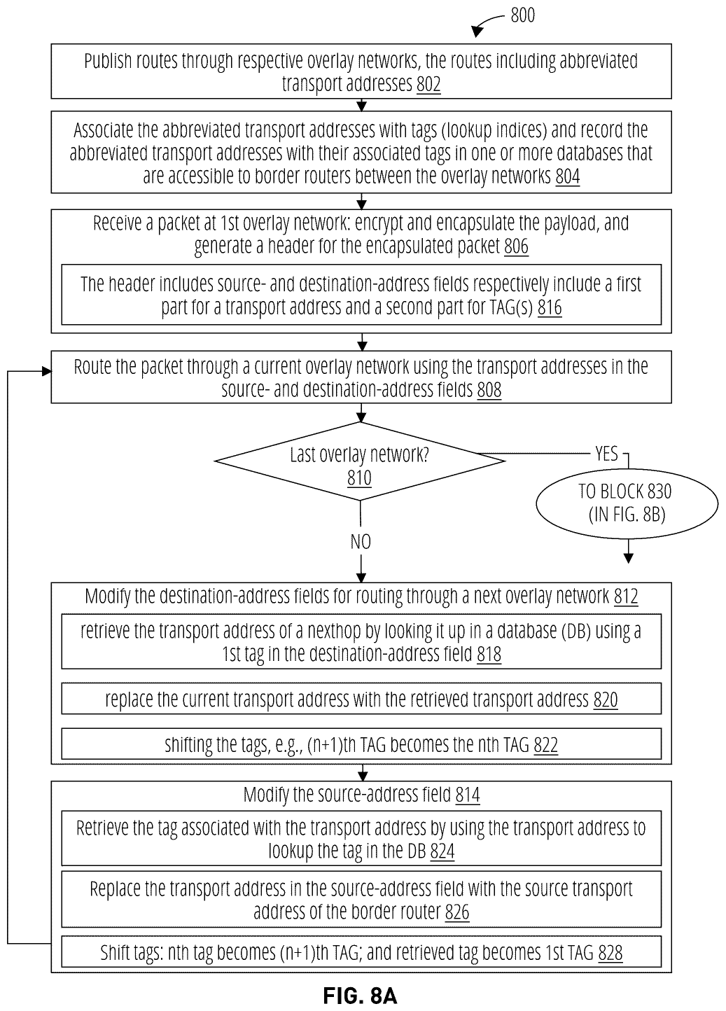

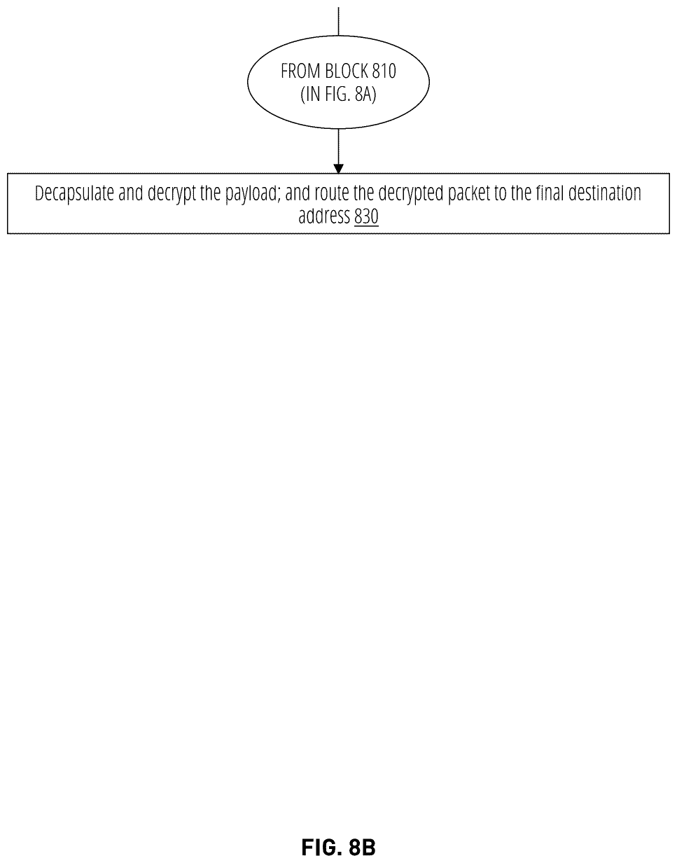

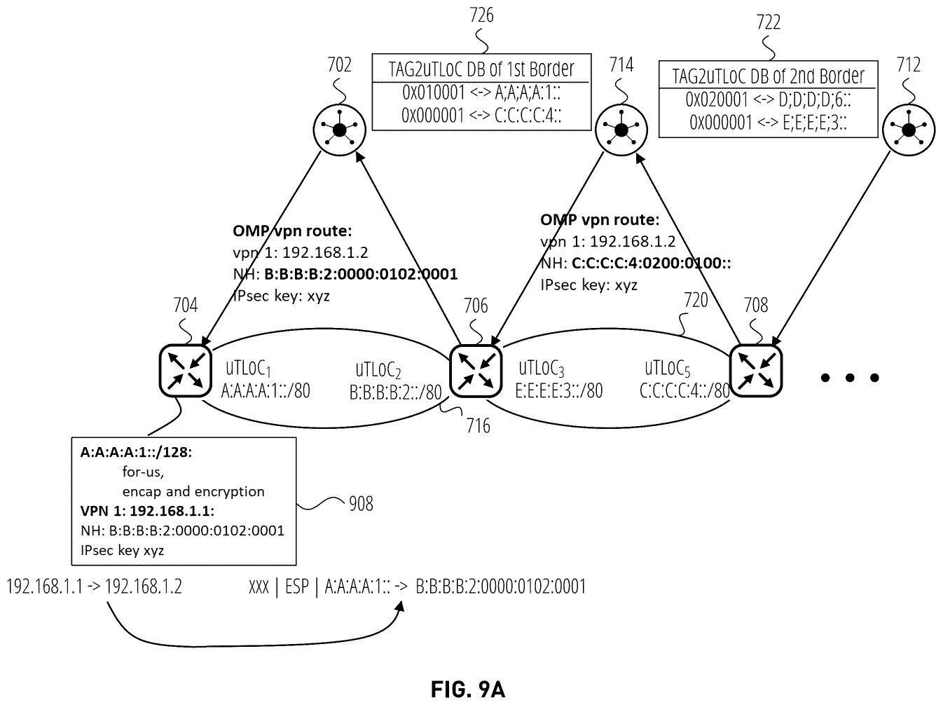

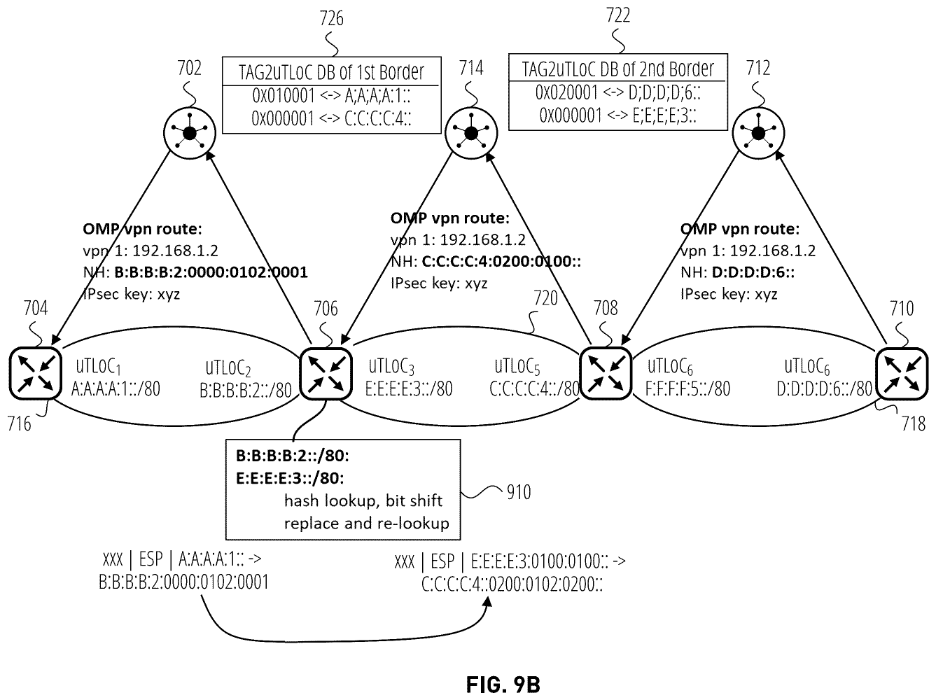

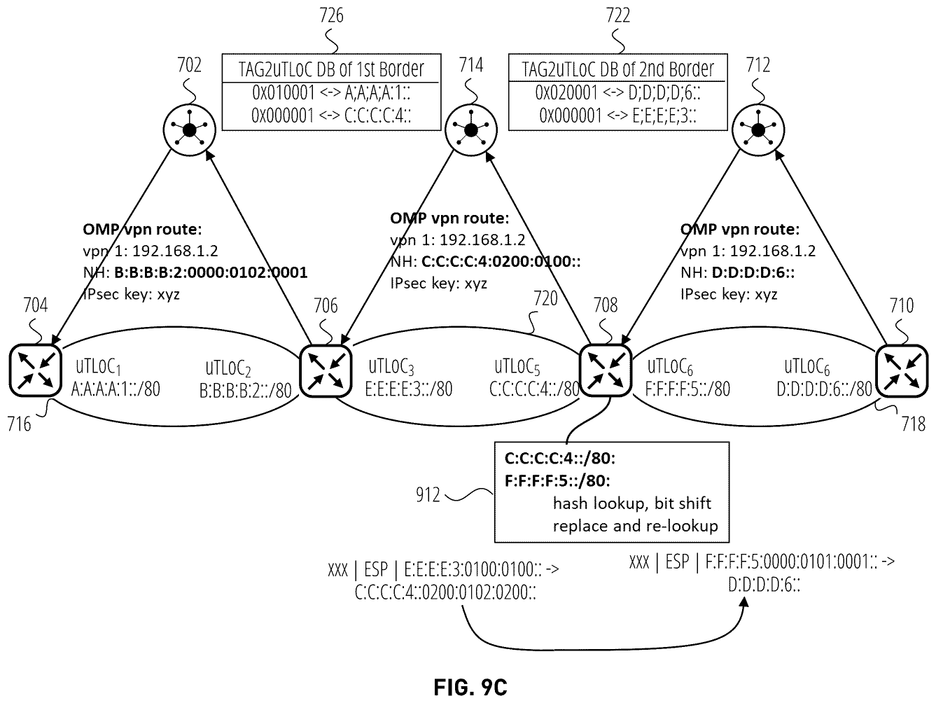

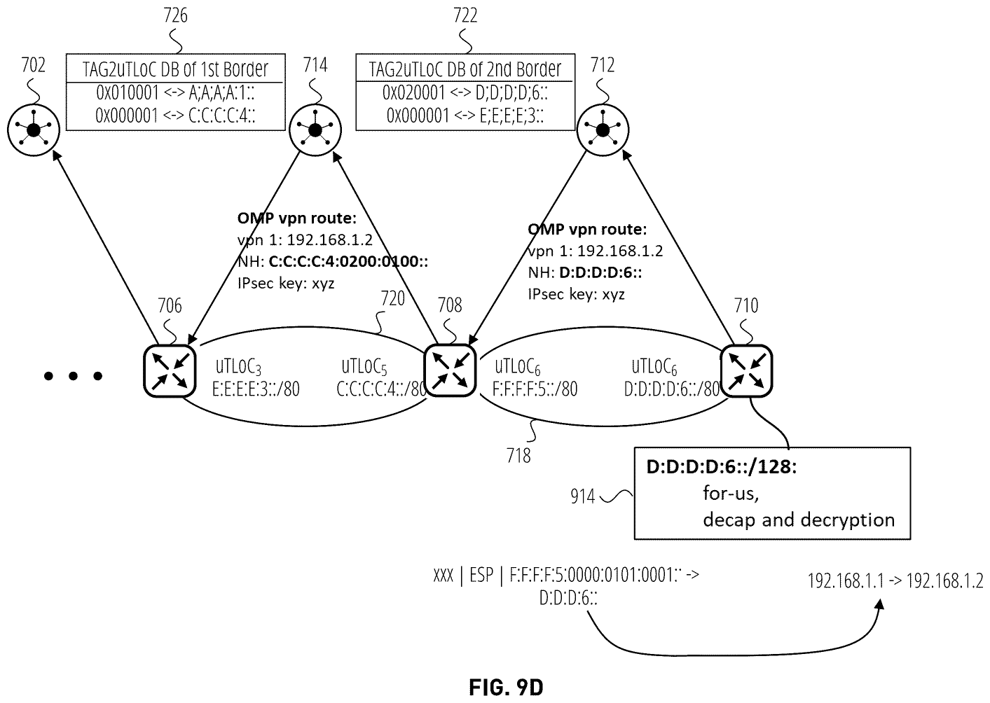

After the VPN route has been established, the VPN route can be used to route packets from the source region access router (e.g., border router 704) to the remote access router (e.g., border router 710) without decrypting and re-encrypting between overlay networks. FIG. 8A and FIG. 8B provide a flow diagram of method 800 for this process, and FIG. 9A, FIG. 9B, FIG. 9C, and FIG. 9D provide a non-limiting example of how this routing is performed for network 700, which is illustrated in FIG. 7C.

FIG. 8A illustrates an example method 800 for routing packets from the source region access router (e.g., border router 704) to the remote access router (e.g., border router 710) without decrypting and re-encrypting between overlay networks. Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements method 800 may perform functions at substantially the same time or in a specific sequence.

According to some examples, block 802 of the method includes publishing routes through respective overlay networks, the routes including abbreviated transport addresses. For example, the core region 720 that is illustrated in FIG. 7A may publish routes through respective overlay networks, the routes including abbreviated transport addresses. An overlay management protocol (OMP) publishes the routes. For example, in Hierarchical SDWAN deployment, when TLOC routes are published via the OMP protocol, border routers will receive TLOC information (including the uTLOC routes and transport addresses) from its access region and core region.

For example, when a VPN route is published from the remote region's access router, the VPN route will carry its uTLOC as nexthop. when the border router redistributes this VPN route, the border router will get the original nexthop's high 80 bits to do a hash look up in TAG2UTLOC DB to get a 24-bit TAG. Then, at the next overlay network, the value in the address field is right-shifted, moving the original nexthop 24 bits to the right. Next, the uTLOC of the border router and the TAG that is retrieved for the nexthop are inserted in the address field as the high 104 bits. Each border router repeats this behavior. Finally, the source region's edge receives this VPN route with nexthop being the combination of the local border router's uTLOC, the remote border router's TAG, and the remote access router's TAG, which totals 128 bits.

According to some examples, block 804 of the method includes associating the abbreviated transport addresses with TAGs (lookup indices) and record the abbreviated transport addresses with their associated TAGs in one or more databases that are accessible to border routers between the overlay networks.

For example, TAG2uTLoC DB of 2nd border 722 illustrated in FIG. 7B may associate the abbreviated transport addresses with TAGs (lookup indices) and record the abbreviated transport addresses with their associated TAGs in one or more databases that are accessible to border routers between the overlay networks. When receiving uTLOC route, a region allocates an unused TAG (e.g., a lookup index having a length of 24 bits) for that new uTLOC in the tag together with the associated transport address are recorded in a TAG2UTLOC database. The transport address can be, e.g., 24 bits, which can be split into an 8-bit region code and a 16-bit TLOC code representing TLOC routes. For example, the 8-bit region code can represent at most 256 regions or sub-regions that each border router can serve, and the 16-bit TLOC code can represent at most 65535 TLOCs within each region.

According to some examples, block 806 of the method includes receiving a packet at 1st overlay network: encrypt and encapsulate the payload and generate a header for the encapsulated packet.

According to certain non-limiting examples, block 806 can include block 816. In block 816 the header is generated to include source-and destination-address fields, which respectively include a first part for a transport address and a second part for TAG(s). For example, the header includes source-and destination-address fields respectively, including a first part for a transport address and a second part for TAG(s). For example, these addressed fields are the VPN routes that are published and redistributed, as described with respect to FIG. 7C.

For example, border router 704 may receive a packet at 1st overlay network: encrypt and encapsulate the payload, and generate a header for the encapsulated packet. An IPv6 standard header includes address fields that are 128 bits long. In place of the standard IPv6 addresses, an abbreviated transport address (e.g., 80 bits in length) can be concatenated with two TAGs (e.g., each being 24 bits in length). Thus, the 128 bits in the address fields can include sufficient information to route the encrypted, encapsulated packet through three overlay networks without decapsulating and decrypting between overlay networks.

According to some examples, block 808 of the method includes routing the packet through a current overlay network using the transport addresses in the source-and destination- address fields. For example, the first region 716 may route the packet through a current overlay network using the transport addresses in the source-and destination-address fields.

According to some examples, decision block 810 inquires whether the last overlay network has been traversed. That is, whether the packet has arrived at the destination region's edge router (e.g., border router 710 in FIG. 9D). When the packet has traversed the last overlay network (e.g., second region 718), method 800 continues to block 830. Otherwise, method 800 continues to block 812.

According to some examples, block 812 of the method includes modifying the destination-address fields for routing through the next overlay network. According to certain non-limiting examples, block 812 can include block 818, block 820, and block 822. Block 818 includes retrieving the transport address of a nexthop by looking it up in a database (DB) using a 1st tag in the destination-address field. Block 820 includes replacing the current transport address with the retrieved transport address. Block 822 includes shifting the TAGs, such that the (n+1)th tag becomes the nth tag. In the example shown in FIG. 9B and FIG. 9C, this is accomplished by left shifting the address by the length of the TAGs (e.g., 24 bits). However, the same functionality can be realized by any other way of identifying which bits in the source address encode which of the TAGs. Any method of recording the TAG information in the source-address field can be used, as long as the information of the respective TAGs can be obtained from the source-address field.

For example, border router 706 may modify the destination-address fields for routing through the next overlay network. As illustrated in FIG. 9B, the incoming packet is routed to border router 706 because the destination-address field directs the packet to B:B:B:B:2::/80. At border router 706, the TAG for the destination address of the nexthop is located in bits [80:103]. Using this TAG (i.e., “000001), a hash is performed in TAG2UTLOC DB to look up the nexthop uTLOC address (i.e., C:C:C:C:4::). Next, the destination-address field is left shifted 24 bits, and the high 80 bits are replaced with the retrieved value of the nexthop uTLOC address (i.e., C:C:C:C:4), resulting in the modified destination-address field becoming C:C:C:C:4:0200:0100::. Then, in block 808, the border router uses the modified destination- address field to re-look up the TLOC route, and packet is forwarded to border router 708 because border router 708 has published its uTLOC C:C:C:C:4::/80.

According to some examples, block 814 of the method includes modifying the source-address field. According to certain non-limiting examples, block 812 can include block 824, block 826, and block 828. Block 824 includes retrieving the tag associated with the transport address by using the transport address to look up the tag in the DB. Block 826 includes replacing the transport address in the source-address field with the source transport address of the border router. Block 828 includes shifting the TAGs, such that the nth TAG becomes (n+1)th TAG, and the retrieved TAG becomes the 1st TAG. In the example shown in FIG. 9B and FIG. 9C, this is accomplished by right-shifting the address by the length of the TAGs (e.g., 24 bits) and replacing the bits 81-105 by the retrieved TAG. However, the same functionality can be realized by any other way of identifying which bits in the source address encode which of the TAGs. Any method of recording the TAG information in the source-address field can be used, as long as the information of the respective TAGs can be obtained from the source-address field.

For example, border router 706 may modify the source-address field. As illustrated in FIG. 9B, border router 706 can change the packet source transport address in the source-address field, according to the egress uTLOC of border router 706. The purpose of this operation is to provide information of the return path the source routers (i.e., border router 704) in case there is a returned packet (e.g., ICMP packet) back to source region access router. The process of modifying the source address (i.e., block 814) is the reverse of process of modifying the destination address. That is, the border router used the high 80 bits (e.g., A:A:A:A:1) in the received source address to find the source TAG (e.g., 010001). Then right-shift the source address by 24 bits of source address, and insert the egress uTLOC address (e.g., E:E:E:E:3) together with the retrieved source TAG (e.g., 010001) into high 104 bits of the source-address field. resulting in the modified source-address field becoming E:E:E:E:3:0100:0100::. This process is then repeated in FIG. 9C.

According to some examples, block 830 of the method includes decapsulating and decrypting the payload. The packets corresponding to decrypted payload are then routed to the final destination address.

For example, border router 710 may decapsulate and decrypt the payload; and route the decrypted packet to the final destination address. As illustrated in FIG. 9D, when the packet reaches last overlay network, the destination-address field is D:D:D:D:6::, resulting in the packet having been routed to the border router corresponding to uTLOC transport address D:D:D:D:6::/128 (i.e., border router 710). Accordingly, border router 710 decapsulates the outer header and decrypts this packet using key xyz according to the Security Parameter Index (SPI) in the Encapsulating Security Payload (ESP) header. Finally, the payload packet is forwarded in VPN 1 (e.g., transport address 192.168.1.2).

FIG. 9A to FIG. 9D illustrate an example of using a combination of TAG2uTLOC databases and IPv6 headers including uTLOC addresses to send encapsulated-encrypted data across multiple overlay networks without decapsulating and decrypting between overlay networks.

FIG. 9A shows a source region access router (e.g. border router 704) receiving service LAN traffic to 192.168.1.2, and the source region access router encrypts and encapsulates the payload and provides a transport IPv6 address of B:B:B:B:2:0000:0102:0001 and encryption with remote access router's IPsec key xyz. This packet will reach local border router according to routing table longest match. Local border router will process this packet according to its routing table action programmed by uTLOC prefix entry.

As shown in in FIG. 9A, for border router 704, the address pair [source address→destination address] of the ingress packet is [192.168.1.1→192.168.1.2]. Then, after performing instructions 908, the address pair of the egress packet is [xxx|ESP|A:A:A:A:1::→B:B:B:B:2:0000:0102:0001].

In IPv6, the acronym SPI stands for Security Parameter Index (SPI) is a value in the Encapsulating Security Payload (ESP) header that identifies the security association (SA) to which a packet belongs. The SA specifies the security properties that the communicating hosts recognize. The SPI allows a receiver to map inbound traffic to an SA.

FIG. 9B shows that the incoming packet hits B:B:B:B:2::/80 (e.g., border router 706). According to programmed action (e.g., instructions 910), border router 706 gets the destination address bits [80:103] (i.e. 000001) and uses this to do a hash look up in TAG2UTLOC DB of 1st Border 726 to get the nexthop uTLOC address (i.e., C:C:C:C:4::). Then, border router 706 left-shifts the destination address by 24 bits and replaces the high 80 bits with C:C:C:C:4, resulting in a new destination address of C:C:C:C:4:0200:0100::. Then, border router 706 uses this new destination address to re-look up and forward the packer to border router 710 because border router 710 has published its uTLOC transport address as beingC:C:C:C:4::/80.

Border router 706 also changes the packet source transport address according to its egress uTLOC (e.g., E:E:E:E:3) to provide information of the return path back to border router 704. This return path can be used, e.g., to allow a returned packet like an ICMP packet to return to the source region access router (e.g., border router 704). Source address operation is the reverse of destination address operation. That is, use high 80 bits (A:A:A:A:1) to find the source TAG (i.e., 010001), right-shift the source address by 24 bits and insert the egress uTLOC address (i.e., E:E:E:E:3) in the 80 high bits, and insert the found source TAG (010001) into bits. 81-105, resulting in the new source address being E:E:E:E:3:0100:0100::.

As shown in in FIG. 9B, for border router 706, the address pair of the ingress packet is [xxx|ESP|A:A:A:A:1::→B:B:B:B:2:0000:0102:0001]. Then, after performing instructions 910, the address pair of the egress packet is [xxx|ESP|E:E:E:E:3:0100:0100:::→C:C:C:C:4:0200:0102:0200:: ].

FIG. 9C shows a repeat of the process in FIG. 9B, except for border router 708 rather than border router 706.

As shown in in FIG. 9C, for border router 708, the address pair of the ingress packet is [xxx|ESP|E:E:E:E:3:0100:0100:::→C:C:C:C:4::0200:0102:0200::]. Then, after performing instructions 912, the address pair of the egress packet is [xxx|ESP|F:F:F:F:5:0000:0101:0001::→D:D:D:D:6::].

When packet reaches last access router, destination address is D:D:D:D:6::, which hits D:D:D:D:6::/128, whose action is for-us. So last access router will de-capsulate outer header and decrypt this packet using key xyz according to SPI in ESP header. Finally the payload packet is forwarded in VPN 1.

As shown in in FIG. 9D, for border router 710, the address pair of the ingress packet is [xxx|ESP|F:F:F:F:5:0000:0101:0001::→D:D:D:D:6::]. Then, after performing instructions 914, the address pair of the egress packet is [192.168.1.1→192.168.1.2].

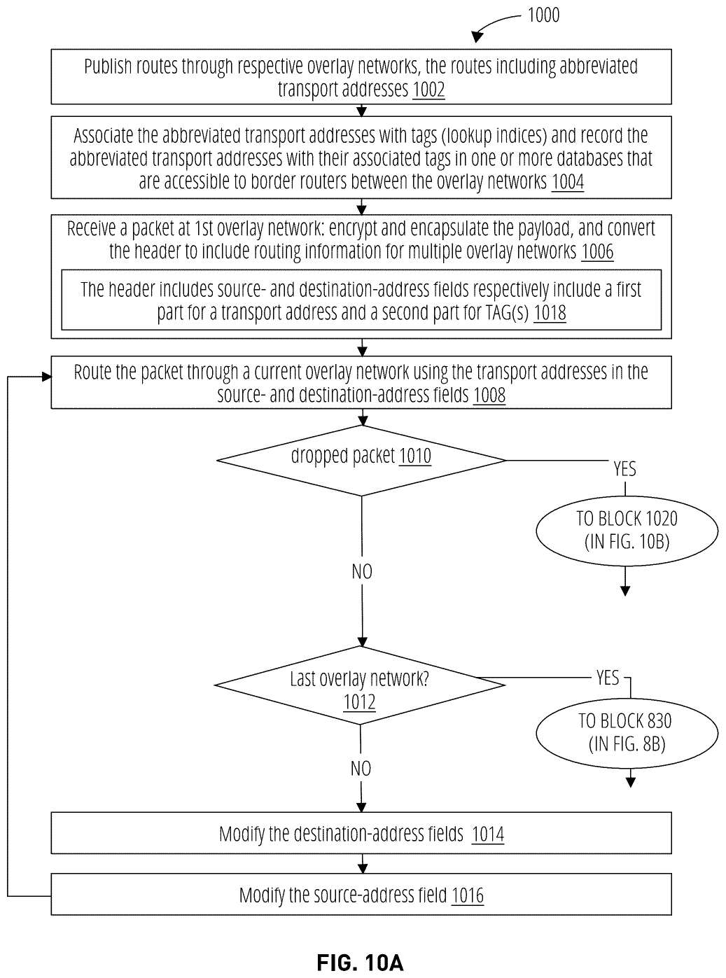

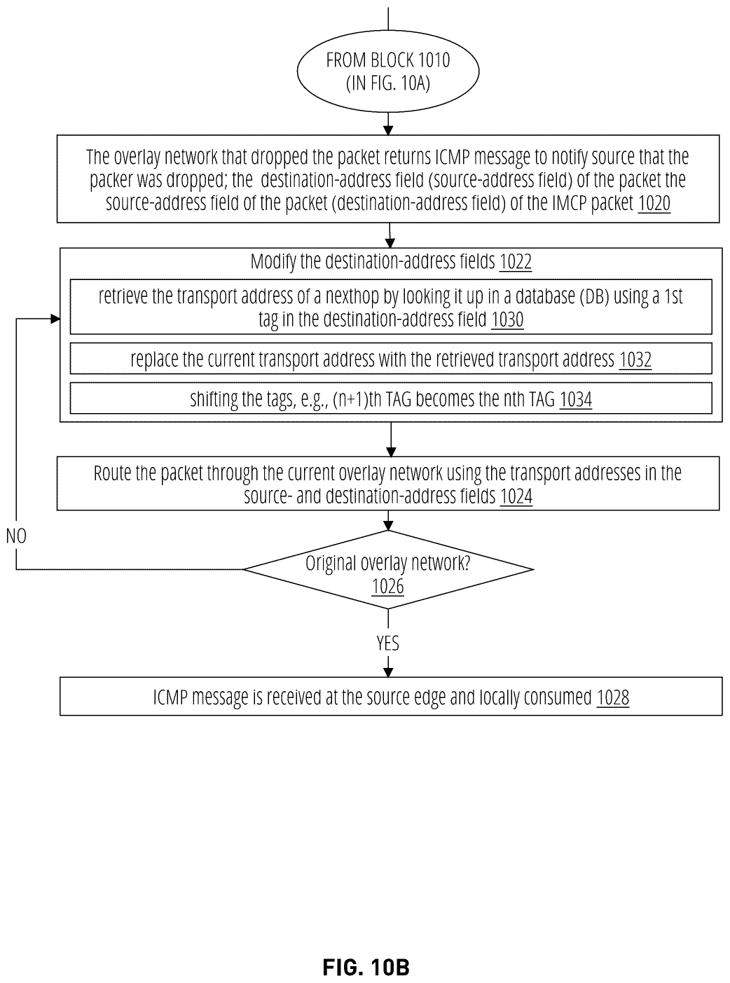

FIG. 10A and FIG. 10B illustrates an example method 1000 for routing packets from the source region access router (e.g., border router 704) to the remote access router (e.g., border router 710) without decrypting and re-encrypting between overlay networks. In contrast to method 800, method 1000 allows for the contingency that a packet is dropped in one of the regions, resulting in an ICMP packet being returned to the source edge. Although the example method 1000 depicts a particular sequence of operations, the sequence may be altered without departing from the scope of the present disclosure. For example, some of the operations depicted may be performed in parallel or in a different sequence that does not materially affect the function of the method 1000. In other examples, different components of an example device or system that implements the method 1000 may perform functions at substantially the same time or in a specific sequence.

According to some examples, the method includes publishing routes through respective overlay networks, the routes including abbreviated transport addresses at block 1002.

For example, border router 704 illustrated in FIG. 7B may publish TLOC routes through respective overlay networks, the routes including abbreviated transport addresses (e.g., uTLOC transport addresses). An overlay management protocol (OMP) publishes the routes. For example, in Hierarchical SDWAN deployment, when TLOC routes are published via the OMP protocol, border routers will receive TLOC information (including the uTLOC routes and transport addresses) from its access region and core region.

For example, when a VPN route is published from the remote region's access router, the VPN route will carry its uTLOC as the nexthop. when the border router redistributes this VPN route, the border router will get the original nexthop's high 80 bits to do a hash look up in TAG2UTLOC DB to get a 24-bit TAG. Then, at the next overlay network, the value in the address field is right-shifted, moving the original nexthop 24 bits to the right. Next, the uTLOC of the border router and the TAG that is retrieved for the nexthop are inserted in the address field as the high 104 bits. Each border router repeats this behavior. Finally, the source region's edge receives this VPN route with nexthop being the combination of local border router's uTLOC and remote border router's TAG and the remote access router's TAG, which totals 128 bits.

According to some examples, the method includes associating the abbreviated transport addresses with TAGs (lookup indices) and record the abbreviated transport addresses with their associated TAGs in one or more databases that are accessible to border routers between the overlay networks at block 1004. For example, the TAG2uTLoC DB of 1st Border 726 illustrated in FIG. 7B may associate the abbreviated transport addresses with TAGs (lookup indices) and record the abbreviated transport addresses with their associated TAGs in one or more databases that are accessible to border routers between the overlay networks. When receiving uTLOC route, a region allocates an unused TAG (e.g., a lookup index having a length of 24 bits) for that new uTLOC in the tag together with the associated transport address are recorded in a TAG2UTLOC database. The transport address can be, e.g., 24 bits, which can be split into an 8-bit region code and a 16-bit TLOC code representing TLOC routes. For example, the 8-bit region code can represent at most 256 regions or sub-regions that each border router can serve, and the 16-bit TLOC code can represent at most 65535 TLOCs within each region.

According to some examples, block 1006 of method 1000 includes receiving a packet at 1st overlay network, encrypting and encapsulating the payload, and converting the header to include routing information for multiple overlay networks.

According to certain non-limiting examples, block 1006 can include block 1018. In block 1018 the header is generated to include source-and destination-address fields, which respectively include a first part for a transport address and a second part for TAG(s). For example, border router 704 illustrated in FIG. 6B and FIG. 7C, the header includes source-and destination- address fields respectively, which include a first part for a transport address and a second part for TAG(s). For example, these addressed fields are the VPN routes that are published and redistributed, as described with respect to FIG. 7C.

For example, border router 704 may receive a packet at 1st overlay network: encrypt and encapsulate the payload, and generate a header for the encapsulated packet. An IPv6 standard header includes address fields that are 128 bits long. In place of the standard IPv6 addresses, an abbreviated transport address (e.g., 80 bits in length) can be concatenated with two tags (e.g., each being 24 bits in length). Thus, the 128 bits in the address fields can include sufficient information to route the encrypted, encapsulated packet through three overlay networks without decapsulating and decrypting between overlay networks.

According to some examples, block 1008 of the method includes routing the packet through a current overlay network using the transport addresses in the source-and destination- address fields. For example, the first region 716 may route the packet through a current overlay network using the transport addresses in the source-and destination-address fields.

According to some examples, decision block 1010 inquires whether the packet was dropped in while routing the packer through the current overlay network. If the packet was dropped, method 1000 continues to block 1022. Otherwise, method 1000 continues to decision block 1012.

According to some examples, decision block 1012 inquires whether the last overlay network has been traversed. That is, whether the packet has arrived at the destination region's edge router. When the packet has traversed the last overlay network (e.g., second region 718), method 1000 continues to block 830. Otherwise, method 800 continues to block 1014.

According to some examples, block 1014 of the method includes modifying the destination-address fields. For example, block 1014 can be performed the same as block 812 in FIG. 8A.

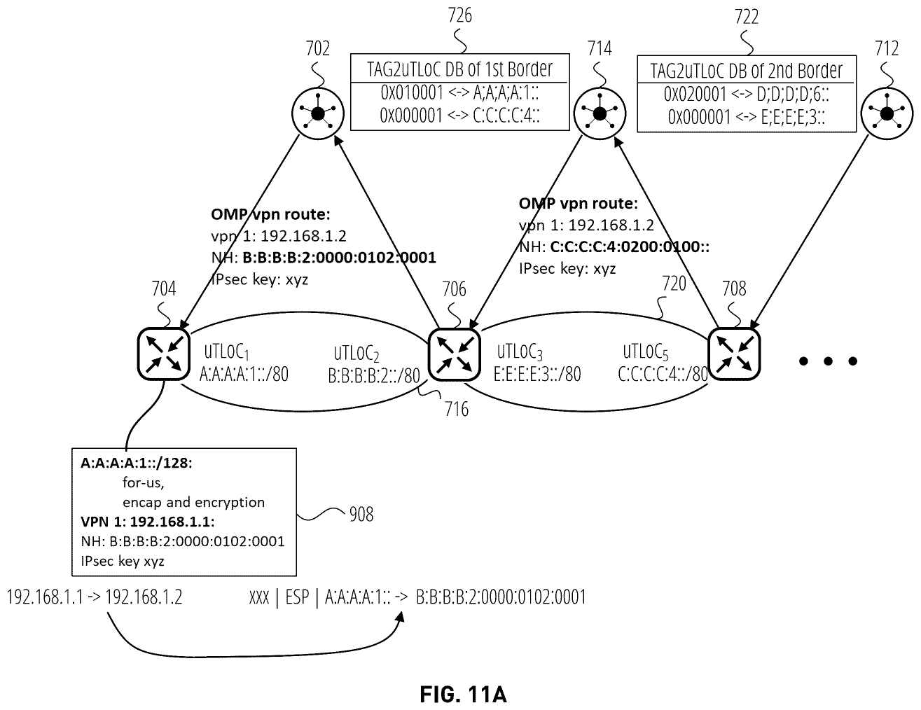

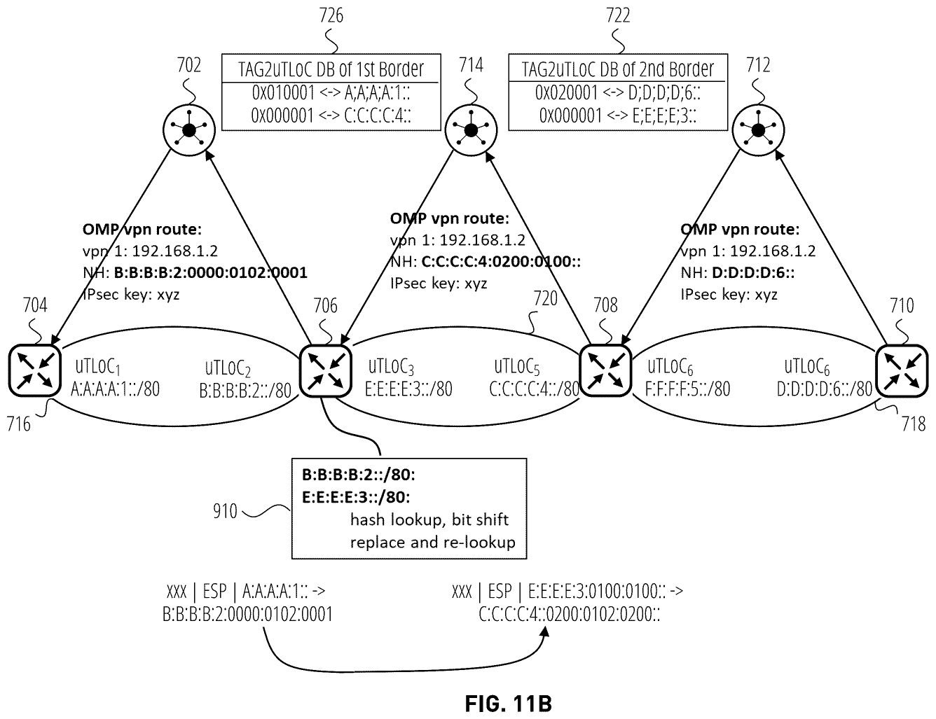

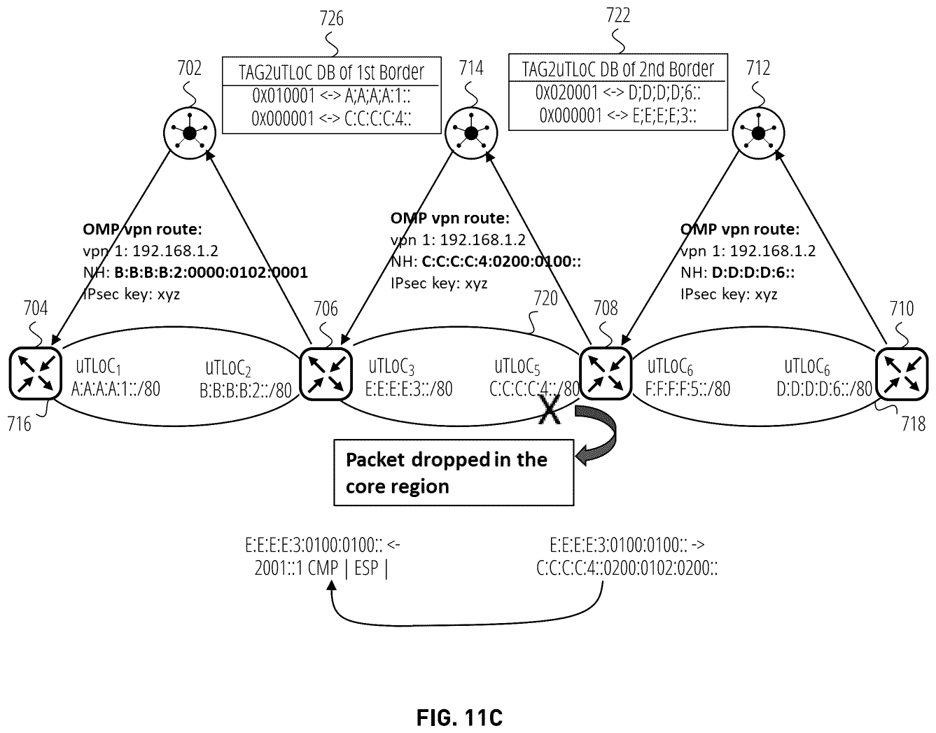

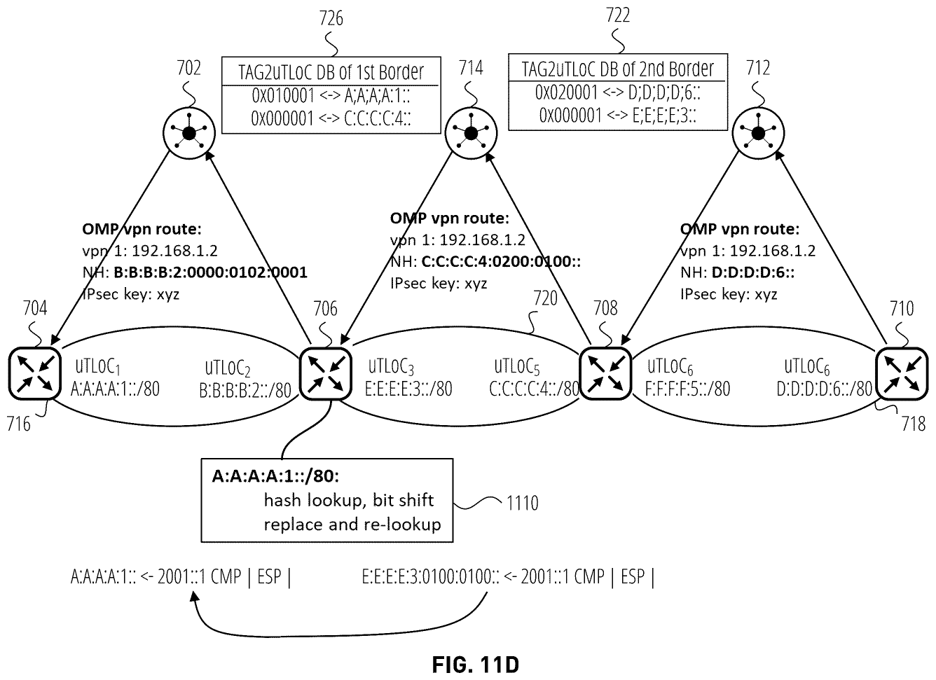

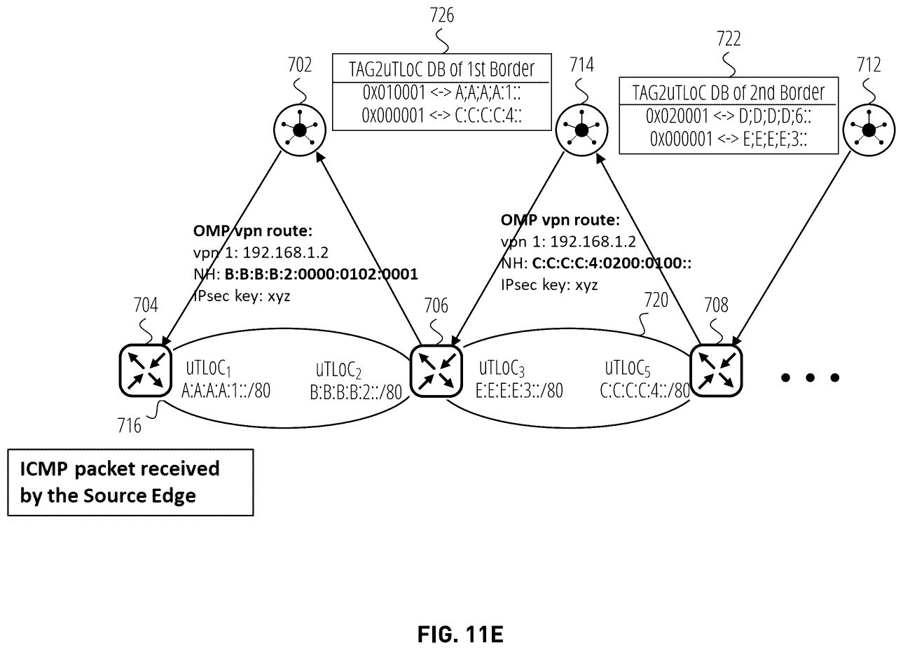

For example, border router 706 illustrated may modify the destination-address fields for routing through the next overlay network. As illustrated in FIG. 11B, the incoming packet is routed to border router 706 because the destination-address field directs the packet to B:B:B:B:2::/80. At border router 706, the TAG for the destination address of the nexthop is located in bits [80:103]. Using this TAG (i.e., “000001), a hash is performed in TAG2UTLOC DB to look up the nexthop uTLOC address (i.e., C:C:C:C:4::). Next, the destination-address field is left shifted 24 bits, and the high 80 bits are replaced with the retrieved value of the nexthop uTLOC address (i.e., C:C:C:C:4), resulting in the modified destination-address field becoming C:C:C:C:4:0200:0100::. Then, in block 1008, the border router uses the modified destination-address field to re-look up the TLOC route, and packet is forward to border router 708 because border router 708 has published its uTLOC C:C:C:C:4::/80.

According to some examples, block 1016 of the method includes modifying the source-address field. For example, block 1016 can be performed the same as block 814 in FIG. 8A.

For example, border router 706 may modify the source-address field. As illustrated in FIG. 11B, border router 706 can change the packet source transport address in the source-address field, according to the egress uTLOC of border router 706. The purpose of this operation is to provide information of the return path the source routers (i.e., border router 704) in case there is a returned packet (e.g., ICMP packet) back to source region access router. The process of modifying the source address (i.e., block 1016) is the reverse of process of modifying the destination address. That is, the border router used the high 80 bits (e.g., A:A:A:A:1) in the received source address to find the source TAG (e.g., 010001). Then right-shift the source address by 24 bits of source address, and insert the egress uTLOC address (e.g., E:E:E:E:3) together with the retrieved source TAG (e.g., 010001) into high 104 bits of the source-address field. resulting in the modified source-address field becoming E:E:E:E:3:0100:0100::. This process is then repeated in FIG. 11C.

According to some examples, block 1020 of the method includes that the overlay network that dropped the packet returning an Internet Control Message Protocol (ICMP) packet to notify source that the packer was dropped. The destination-address field of the original packet becomes the source-address field of the IMCP packet, and the source-address field of the original packet becomes the destination-address field of the IMCP packet. The ICMP is a network layer protocol used by network devices to diagnose network communication issues and can be used to determine whether or not data is reaching its intended destination in a timely manner, for example.

For example, the core region 720 may return an ICMP packet to notify source that the packer was dropped. As illustrated in FIG. 11C, if the packet is dropped during forward in a particular region/overlay network (e.g. the dropped packet occurs in the core region), the particular region/overlay network returns an ICMPv6 packet to the originating border router (e.g., border router 706). Because the steps along the path have been recorded in the source-address field, the ICMPv6 packet can be returned all the way back to the source edge (e.g., border router 704). As explained with respect to the traffic forwarding process, the source-address field is modified when egressing from the border router. Accordingly, within each region, the ICMP packet can use the original packet's source address as the destination to return the ICMP packet back to the respective border routers.

FIG. 11C shows that the source address of the dropped packet (i.e., E:E:E:E:3:0100:0100::) becomes the destination address of the ICMP packet.

According to some examples, block 1022 of the method includes modifying the destination-address fields. According to certain non-limiting examples, block 1022 includes block 1030, block 1032, and block 1034. Block 1030 includes retrieving the transport address of a nexthop by looking it up in a database (DB) using a 1st tag in the destination-address field. Block 1032 includes replacing the current transport address with the retrieved transport address. Block 1034 includes shifting the TAGs, e.g., (n+1)th tag becomes the nth tag.

For example, border router 706 may modify the destination-address fields for routing through a next overlay network. As illustrated in FIG. 11D, the incoming packet is routed to border router 706 because the destination-address field (i.e., E:E:E:E:3:0100:0100::) directs the packet to E:E:E:E:3::/80. At border router 706, the TAG for the destination address of the nexthop is located in bits [80:103]. Using this TAG (i.e., “010001), a hash is performed in TAG2UTLOC DB of 1st Border 726 to look up the nexthop uTLOC address (i.e., A:A:A:A:1::). Next, the destination-address field is left shifted 24 bits, and the high 80 bits are replaced with the retrieved value of the nexthop uTLOC address (i.e., A:A:A:A:1), resulting in the modified destination-address field becoming A:A:A:A:1::. Then, in block 1024, the border router uses the modified destination-address field to re-look up the TLOC route, and packet is forwarded to border router 704 because border router 704 has published its uTLOC transport address as A:A:A:A:1::.

For example, border router 706 may modify the destination-address fields. As illustrated in FIG. 11D, block 1022 functions identically to block 1016, except that the source-and destination-address fields are swapped, resulting in reversing the effect to the address fields and retracing the original path back to the source edge.

According to some examples, the method includes routing the packet through the current overlay network using the transport addresses in the source-and destination-address fields at block 1024. For example, the first region 716 may route the packet through the current overlay network using the transport addresses in the source-and destination-address fields.

According to some examples, decision block 1026 inquiries whether the current overlay network traversed in block 1024 is the original overlay network. If the current overlay network is not the original overlay network, method 1000 continues to block 1022. Otherwise, method 1000 continues to block 1028.

According to some examples, block 1028 of the method includes receiving the ICMP packet at the source edge and locally consuming the ICMP packet. For example, border router 704 may receive and consume the ICMP packet.

FIG. 11A to FIG. 11E illustrate a case in which a packet is dropped, resulting in an ICMP packet being returned to the source edge.

FIG. 11A shows a source region access router (e.g. border router 704) receiving service LAN traffic to 192.168.1.2, and the source region access router encrypts and encapsulates the payload and provides a transport IPv6 address of B:B:B:B:2:0000:0102:0001 and encryption with remote access router's IPsec key xyz. This packet will reach local border router according to routing table longest match. Local border router will process this packet according to its routing table action programmed by uTLOC prefix entry.

As shown in in FIG. 11A, for border router 704, the address pair [source address->destination address] of the ingress packet is [192.168.1.1→192.168.1.2]. Then, after performing instructions 908, the address pair of the egress packet is [xxx|ESP|A:A:A:A:1::→B:B:B:B:2:0000:0102:0001].

In IPv6, the acronym SPI stands for Security Parameter Index (SPI) is a value in the Encapsulating Security Payload (ESP) header that identifies the security association (SA) to which a packet belongs. The SA specifies the security properties that the communicating hosts recognize. The SPI allows a receiver to map inbound traffic to an SA.

FIG. 11B shows that the incoming packet hits B: B: B: B: 2::/80 (e.g., border router 706). According to programmed action (e.g., instructions 910), border router 706 gets the destination address bits [80:103] (i.e. 000001) and uses this to do a hash look up in TAG2UTLOC DB of 1st Border 726 to get the nexthop uTLOC address (i.e., C:C:C:C:4::). Then, border router 706 left-shifts the destination address by 24 bits and replaces the high 80 bits with C:C:C:C:4, resulting in a new destination address of C:C:C:C:4:0200:0100::. Then, border router 706 uses this new destination address to re-look up and forward the packer to border router 710 because border router 710 has published its uTLOC transport address as beingC:C:C:C:4::/80.

Border router 706 also changes the packet source transport address according to its egress uTLOC (e.g., E:E:E:E:3) to provide information of the return path back to border router 704. This return path can be used, e.g., to allow a returned packet like an ICMP packet to return to the source region access router (e.g., border router 704). Source address operation is the reverse of destination address operation. That is, use high 80 bits (A:A:A:A:1) to find the source TAG (i.e., 010001), right-shift the source address by 24 bits and insert the egress uTLOC address (i.e., E:E:E:E:3) in the 80 high bits, and insert the found source TAG (010001) into bits. 81-105, resulting in the new source address being E:E:E:E:3:0100:0100::.

As shown in in FIG. 11B, for border router 706, the address pair of the ingress packet is [xxx|ESP|A:A:A:A:1::→B:B:B:B:2:0000:0102:0001]. Then, after performing instructions 910, the address pair of the egress packet is [xxx|ESP|E:E:E:E:3:0100:0100:::→C:C:C:C:4::0200:0102:0200:].

FIG. 11C illustrates the packet being dropped as it is being routed through core region 720. When the packet is dropped while being forwarded (e.g. packet is dropped in core region 720, as illustrated in FIG. 11C), an ICMPv6 packet can be sent to the source edge. The source address field allows the ICMP packet to retrace the path in reverse, allowing the ICMP packet to return to the source edge. As explained above for the traffic forwarding process, the packet source address is changed before egressing from the respective border routers, preserving a record of the transport addresses for the return to the source edge (e.g., border router 704). Accordingly, the ICMP packet can use the original packet's source address as the new destination address to return back to the border router.

As shown in FIG. 11C. The destination address of the ICMP packet is E:E:E:E:3:0100:0100:: (i.e. original packet's source address). Accordingly, this ICMP packet will be forwarded to border router 706 and finally back to the source access router where it is locally consumed.

FIG. 11D illustrates modifying the destination-address field at border router 706 so that the ICMP packet can be forwarded to border router 704. Here, border router 706 modifies the destination-address fields for routing through a next overlay network. As illustrated in FIG. 11D, the incoming packet is routed to border router 706 because the destination-address field (i.e., E:E:E:E:3:0100:0100::) directs the packet to E:E:E:E:3::/80. At border router 706, the TAG for the destination address of the nexthop is located in bits [80:103]. Using this TAG (i.e., “010001), a hash is performed in TAG2UTLOC DB of 1st Border 726 to look up the nexthop uTLOC address (i.e., A:A:A:A:1::). Next, the destination-address field is left shifted 24 bits, and the high 80 bits are replaced with the retrieved value of the nexthop uTLOC address (i.e., A:A:A:A:1), resulting in the modified destination-address field becoming A:A:A:A:1::. Then, in block 1024, the border router uses the modified destination-address field to re-look up the TLOC route, and packet is forward to border router 704 because border router 704 has published its uTLOC transport address as A:A:A:A:1::.

As shown in in FIG. 9B, for border router 706, the address pair of the ingress packet is [2001::1CMP|ESP|→E:E:E:E:3:0100:0100::]. Then, after performing instructions 1110, the address pair of the egress packet is [2001::1CMP|ESP|→A:A:A:A:1::].

FIG. 11E illustrates the ICMP packet arriving at border router 704 after having been forwarded from border router 706. As discussed above, when the original packet is dropped during the forwarding process, network 700 can send an ICMPv6 packet to source edge, notifying the sender to resend the packet, for example. The source address field allows the ICMP packet to retrace the path in reverse, allowing the ICMP packet top return to the source edge.

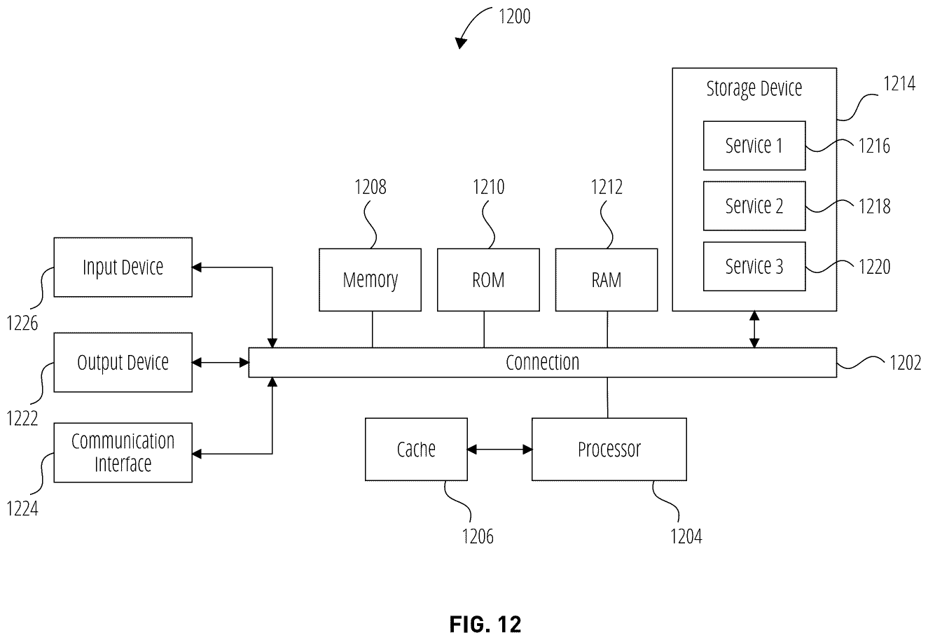

FIG. 12 shows an example of computing system 1200. The computing system 1200 can be a router, switch, network control appliance, network management appliance, or an analytics engine, for example. The computing system 1200 can perform the functions of one or more of network 700 or network architecture 100. The computing system 1200 can be part of a distributed computing network in which several computers perform respective steps in method 800 or 1000 and/or the functions of network 700. The computing system 1200 can be connected to the other parts of the distributed computing network via connection 1202 or communication interface 1224. Connection 1202 can be a physical connection via a bus, or a direct connection into processor 1204, such as in a chipset architecture. Connection 1202 can also be a virtual connection, networked connection, or logical connection.

In some embodiments, computing system 1200 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1200 includes at least one processing unit or CPU (e.g., processor 1204) and connection 1202 that couples various system components including system memory 1208, such as read-only memory (e.g., ROM 1210) and random access memory (e.g., RAM 1212) to processor 1204. Computing system 1200 can include a cache of high-speed memory 1206 connected directly with, in close proximity to, or integrated as part of processor 1204. Processor 1204 may essentially be a completely self-contained computing system, containing multiple cores or processors, a bus, memory controller, cache, etc. A multi-core processor may be symmetric or asymmetric.

Processor 1204 can include any general-purpose processor and a hardware service or software service, such as services 1216, 1218, and 1220 stored in storage device 1214, configured to control processor 1204 as well as a special-purpose processor where software instructions are incorporated into the actual processor design.

To enable user interaction, computing system 1200 includes an input device 1226, which can represent any number of input mechanisms, such as a microphone for speech, a touch-sensitive screen for gesture or graphical input, keyboard, mouse, motion input, speech, etc. Computing system 1200 can also include output device 1222, which can be one or more of a number of output mechanisms known to those of skill in the art. In some instances, multimodal systems can enable a user to provide multiple types of input/output to communicate with computing system 1200. Computing system 1200 can include a communication interface 1224, which can generally govern and manage the user input and system output. There is no restriction on operating on any particular hardware arrangement, and therefore the basic features here may easily be substituted for improved hardware or firmware arrangements as they are developed.

Storage device 1214 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1214 can include software services, servers, services, etc., that when the code that defines such software is executed by the processor 1204, it causes the system to perform a function. In some embodiments, a hardware service that performs a particular function can include the software component stored in a computer-readable medium in connection with the necessary hardware components, such as processor 1204, connection 1202, output device 1222, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a border router and performs one or more functions of method 800 or method 1000 when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data that cause or otherwise configure a general-purpose computer, special-purpose computer, or special-purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, For example, instructions and data which cause or otherwise configure a general purpose computer, special purpose computer, or special purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method of securely routing data through a series of overlay networks without decrypting and encrypting at boundaries between the overlay networks, the method comprising:
routing a packet along a path through a plurality of overlay networks including a source edge router, a first overlay network, and a second overlay network, wherein the packet includes a payload that is encrypted and a header that is unencrypted, and the header includes a destination-address field that is configured to encode both a nexthop destination address and one or more lookup indices that uniquely identify respective subsequent nexthop destination addresses in a lookup table;
receiving the packet at a first border router between the first overlay network and the second overlay network, the destination-address field encoding at least a first transport address and a first lookup index that uniquely identifies, in a first lookup table, a second transport address corresponding to transport route to a second border router of the second overlay network;
modifying, by the first border router, the destination-address field to include the second destination address to provide a modified header; and
using the destination-address field of the modified header to forward the packet through the second overlay network to the second border router.

2. The method of claim 1, wherein:
the plurality of overlay networks includes a third overlay network that includes the second border router and a destination edge border router,
the destination-address field of the header at the source edge router encodes the first transport address, the first lookup index, and a second lookup index, and
the method further comprises:
using the first transport address of the header to forward the packet through the first overlay network from the source edge router to the first border router;
looking up, at the first border router, a transport address associated with the first lookup index in the first lookup table to provide the second transport address;
modifying, by the first border router, the destination-address field by replacing the first transport address with the second transport address;
looking up, at the second border router, a transport address associated with the second lookup index in a second lookup table to provide the third transport address;
modifying, by the first border router, the destination-address field of the modified header by replacing the second transport address with the third transport address to provide another modified header; and
using the destination-address field of the another modified header to forward the packet through the third overlay network to the destination edge router.

3. The method of claim 1, wherein:
the header includes a source-address field that is configured to encode both a source transport address and a return-path lookup index that uniquely identifies an egress transport address of a previous hop in the lookup table, and
the method further comprises:
looking up, at the first border router, in the first lookup table a lookup index that is associated with the source transport address in the source-address field of the header to provide a third lookup index; and
modifying, by the first border router, the source-address field to replace source transport address in the source-address field with an egress transport address of the first border router and adding the third lookup index to the source-address field to provide a

4. The method of claim 3, further comprising:
returning a notification message indicating that the packet was dropped, when the packet is dropped in the second overlay network, wherein a destination-address field of a header of the notification message at the first border router is the source-address field of the modified header of the packet;
looking up, at the first border router, in the first lookup table a transport address associated with the third lookup index to provide a return-path transport address;
modifying, by the first border router, the destination-address field of the header the notification message by replacing the transport address in the destination-address field of the notification message with the return-path transport address to provide a modified header of the notification message; and
using the destination-address field of the modified header of the notification message to forward the notification message through the first overlay network to the source edge router.

5. The method of claim 1, further comprising:
publishing overlay transports for the plurality of overlay networks, the overlay transports being represented by abbreviated transport addresses that are shorter than a length of the destination-address field;
recording, in a look up accessible by a router at a border between two overlay networks, published transport addresses to other border routers of the two overlay network and associating the published transport addresses with respective lookup indices;
publishing and redistributing virtual network routes through the plurality of overlay networks including a virtual network route that forwards data along the path through the plurality of overlay networks from the source edge router to a destination edge router, wherein a destination address for the virtual network route that is stored at the source edge router includes all information needed to forward the data to the destination edge router, a same key for the virtual network route is redistributed to all border routers along the path including the source edge router, the destination edge router, the first border router, and the second border router;
encrypting, at the source edge router, the packet using the same key for the virtual network route; and
decrypting, at the destination edge router, the packet for a first time using the same key for the virtual network route.

6. The method of claim 1, wherein:
the first transport address representing a transport route from a source router of the first overlay network to the first border router, the destination-address field is configured to encode a destination address in a first part of the destination-address field and to encode one or more lookup indices in a second part of the destination-address field; and
modifying the destination-address field to include the second destination address includes:
searching the first lookup table for the first lookup index and retrieving a transport address associated with the first lookup index, the associated transport address being the second transport address;
replacing the first transport address in the first part of the destination-address field with the second transport address; and
modifying the second part of the destination-address field to indicate that the first lookup index has been used.

7. The method of claim 6, wherein modifying the second part of the destination-address field to indicate that the first lookup index has been used includes:
left-shifting bits in the destination-address field by a number of bits in the first lookup index, or
removing the first lookup index from the destination-address field.

8. The method of claim 6, wherein the first part of the destination-address field includes bits [1, . . . , N] of the destination-address field, the second part of the destination-address field includes bits [N+1, . . . , L], the first lookup index is stored in bits [N+1, . . . , N+M] of the destination-address field, and a second lookup index is stored in bits [N+M+1, . . . , N+2M] of the destination-address field, wherein N is a length for transport addresses, M is a length for lookup indices, and L is a length of the destination-address field.

9. The method of claim 8, wherein modifying the destination-address field of the header is performed by left shifting bits in the destination-address field by M bits and writing over bits [1, . . . , N] with a retrieved transport address from a given lookup table.

10. The method of claim 1, wherein:
the header is an IPv6 header that has a length of 128 bits,
transport addresses that are stored in the header have a length that is between 48 bits and 96 bits; and
lookup indices that are stored in the header have a length that is between 32 bit and 16 bits.

11. The method of claim 1, wherein a hash look up using the first lookup index is used by the first border router to retrieve the second transport address from the first lookup table.

12. A system comprising:
one or more processors; and
a memory storing instructions that, when executed by the one or more processors, configure the system to:
route a packet along a path through a plurality of overlay networks including a source edge router, a first overlay network, and a second overlay network, wherein the packet includes a payload that is encrypted and a header that is unencrypted, and the header includes a destination-address field that is configured to encode both a nexthop destination address and one or more lookup indices that uniquely identify respective subsequent nexthop destination addresses in a lookup table;
receive the packet at a first border router between the first overlay network and the second overlay network, the destination-address field encoding at least a first transport address and a first lookup index that uniquely identifies, in a first lookup table, a second transport address corresponding to transport route to a second border router of the second overlay network;
modify, by the first border router, the destination-address field to include the second destination address to provide a modified header; and
use the destination-address field of the modified header to forward the packet through the second overlay network to the second border router.

13. The system of claim 12, wherein:
the plurality of overlay networks includes a third overlay network that includes the second border router and a destination edge border router,
the destination-address field of the header at the source edge router encodes the first transport address, the first lookup index, and a second lookup index, and
the instructions further configure the system to:
use the first transport address of the header to forward the packet through the first overlay network from the source edge router to the first border router;
look up, at the first border router, a transport address associated with the first lookup index in the first lookup table to provide the second transport address;
modify, by the first border router, the destination-address field by replacing the first transport address with the second transport address;
look up, at the second border router, a transport address associated with the second lookup index in a second lookup table to provide the third transport address;
modify, by the first border router, the destination-address field of the modified header by replacing the second transport address with the third transport address to provide another modified header; and
use the destination-address field of the another modified header to forward the packet through the third overlay network to the destination edge router.

14. The system of claim 12, wherein:
the header includes a source-address field that is configured to encode both a source transport address and a return-path lookup index that uniquely identifies an egress transport address of a previous hop in the lookup table, and
the instructions further configure the system to:
look up, at the first border router, in the first lookup table a lookup index that is associated with the source transport address in the source-address field of the header to provide a third lookup index; and
modify, by the first border router, the source-address field to replace source transport address in the source-address field with an egress transport address of the first border router and adding the third lookup index to the source-address field to provide a

15. The system of claim 14, wherein the instructions further configure the system to:
return a notification message indicating that the packet was dropped, when the packet is dropped in the second overlay network, wherein a destination-address field of a header of the notification message at the first border router is the source-address field of the modified header of the packet;
look up, at the first border router, in the first lookup table a transport address associated with the third lookup index to provide a return-path transport address;
modifying, by the first border router, the destination-address field of the header the notification message by replacing the transport address in the destination-address field of the notification message with the return-path transport address to provide a modified header of the notification message; and
use the destination-address field of the modified header of the notification message to forward the notification message through the first overlay network to the source edge router.

16. The system of claim 12, wherein the instructions further configure the system to:
publish overlay transports for the plurality of overlay networks, the overlay transports being represented by abbreviated transport addresses that are shorter than a length of the destination-address field;
recording, in a look up accessible by a router at a border between two overlay networks, published transport addresses to other border routers of the two overlay network and associating the published transport addresses with respective lookup indices;
publish and redistributing virtual network routes through the plurality of overlay networks including a virtual network route that forwards data along the path through the plurality of overlay networks from the source edge router to a destination edge router, wherein a destination address for the virtual network route that is stored at the source edge router includes all information needed to forward the data to the destination edge router, a same key for the virtual network route is redistributed to all border routers along the path including the source edge router, the destination edge router, the first border router, and the second border router;
encrypt, at the source edge router, the packet using the same key for the virtual network route; and
decrypt, at the destination edge router, the packet for a first time using the same key for the virtual network route.

17. The system of claim 12, wherein:
the first transport address representing a transport route from a source router of the first overlay network to the first border router,
the destination-address field is configured to encode a destination address in a first part of the destination-address field and to encode one or more lookup indices in a second part of the destination-address field; and
the instructions further configure the system to:
modify the destination-address field to include the second destination address includes:
searching the first lookup table for the first lookup index and retrieving a transport address associated with the first lookup index, the associated transport address being the second transport address;
replace the first transport address in the first part of the destination-address field with the second transport address; and
modify the second part of the destination-address field to indicate that the first lookup index has been used.

18. The system of claim 17, wherein the instructions further configure the system to:
modify the second part of the destination-address field to indicate that the first lookup index has been used by:
left-shifting bits in the destination-address field by a number of bits in the first lookup index,
removing the first lookup index from the destination-address field, or
updating a value that signals which lookup index in the destination-address field is used next.

19. The system of claim 17, wherein:
the first part of the destination-address field includes bits [1, . . . ,N] of the destination-address field, the second part of the destination-address field includes bits [N+1, . . . , L], the first lookup index is stored in bits [N+1, . . . ,N+M] of the destination-address field, and a second lookup index is stored in bits [N+M+1,,N+2M] of the destination-address field, wherein N is a length for transport addresses, M is a length for lookup indices, and L is a length of destination-address field, and
the instructions further configure the system to modify the destination-address field of the header by left shifting bits in the destination-address field by M bits and writing over bits [1, . . . ,N] with a retrieved transport address from a given lookup table.

20. A non-transitory computer-readable storage medium, the computer-readable storage medium including instructions that when executed by a computer, cause the computer to:
route a packet along a path through a plurality of overlay networks including a source edge router, a first overlay network, and a second overlay network, wherein the packet includes a payload that is encrypted and a header that is unencrypted, and the header includes a destination-address field that is configured to encode both a nexthop destination address and one or more lookup indices that uniquely identify respective subsequent nexthop destination addresses in a lookup table;
receive the packet at a first border router between the first overlay network and the second overlay network, the destination-address field encoding at least a first transport address and a first lookup index that uniquely identifies, in a first lookup table, a second transport address corresponding to transport route to a second border router of the second overlay network;
modify, by the first border router, the destination-address field to include the second destination address to provide a modified header; and
use the destination-address field of the modified header to forward the packet through the second overlay network to the second border router.
